(19) United States
(12) Patent Application Publication
(10) Pub. No.: US 2026/0213261 A1
(43) Pub. Date: Jul. 23, 2026

(54) COMPOSITE SOLID ELECTROLYTE, METHOD OF PREPARING THE SAME, AND LITHIUM BATTERY INCLUDING THE SAME

(71) Applicant: Samsung Electronics Co., Ltd., Suwon-si (KR)

(72) Inventors: Youngjoon Bae, Suwon-si (KR); Giyun Kwon, Suwon-si (KR); Hyeokjo Gwon, Suwon-si (KR); Taeyoung Kim, Suwon-si (KR); Hwiyeol Park, Suwon-si (KR)

(21) Appl. No.: 19/439,571

(22) Filed: Jan. 5, 2026

(30) Foreign Application Priority Data
Jan. 23, 2025 (KR) 10-2025-0010663

(51) Int. Cl. H01M 10/0562; H01M 10/052

(52) U.S. Cl. CPC H01M 10/0562; H01M 10/052; H01M 2300/0071; H01M 2300/0094

(57) ABSTRACT

Disclosed are a composite solid electrolyte, a method of preparing the same, and a lithium battery including the same. The composite solid electrolyte includes a first solid electrolyte containing a cubic garnet phase, and a second solid electrolyte containing a lithium haloboracite, where the first solid electrolyte is a garnet-containing solid electrolyte including a compound having a cubic crystal phase and represented by Formula 1, the composite solid electrolyte has a peak at about −2 ppm to about 8 ppm in a ⁷Li nuclear magnetic resonance spectrum, and the peak has a full width at half maximum of about 0.3 ppm to about 4.0 ppm, the lithium haloboracite includes chlorine, bromine, iodine, or a combination thereof, and the first solid electrolyte has a larger volume than the second solid electrolyte.

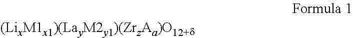

wherein, in Formula 1, M1, M2, A, and o are as defined in the detailed description.

### CROSS-REFERENCE TO RELATED APPLICATION

This application is based on and claims priority to Korean Patent Application No. 10-2025-0010663, filed on Jan. 23, 2025, in the Korean Intellectual Property Office, and all the benefits accruing therefrom under 35 U.S.C. § 119, the disclosure of which is incorporated by reference herein in its entirety.

### BACKGROUND

### 1. Field

The disclosure relates to a composite solid electrolyte, a method of preparing the composite solid electrolyte, and a lithium battery including the composite solid electrolyte.

### 2. Description of the Related Art

Lithium batteries provide improved specific energy (Wh/kg) and/or energy density (Wh/cc).

Lithium batteries may include solid electrolytes for improved stability. When using solid electrolytes, there is little or no risk of fire, and manufacturing processes can be simplified.

Among solid electrolytes, a garnet oxide solid electrolyte is one of the materials having high ionic conductivity, and is known as a key material for all-solid-state secondary batteries because of its excellent chemical stability with lithium. The garnet oxide solid electrolyte has high theoretical lithium-ion conductivity, as an oxide-containing material it can undergo a densification process through sintering at a high temperature of about 1200° C. to have excellent lithium-ion conductivity. For this purpose, methods of lowering a sintering temperature by introducing various sintering agents are being used. However, when using sintering agents in this way, there is a limit to the range of improvement in sintering temperature, and when a garnet oxide solid electrolyte and a sintering agent are used together, additional interface formation and side reaction issues may arise.

### SUMMARY

Provided a composite solid electrolyte capable of low-temperature sintering and having high conductivity and improved relative density.

Provided a lithium battery including the composite solid electrolyte.

Provided a method of preparing the composite solid electrolyte.

Additional aspects will be set forth in part in the description which follows and, in part, will be apparent from the description, or may be learned by practice of the presented embodiments of the disclosure.

According to an aspect of the disclosure, a composite solid electrolyte includes a first solid electrolyte containing a cubic garnet phase, and a second solid electrolyte containing a lithium haloboracite,
wherein the first solid electrolyte is a garnet-containing solid electrolyte including a compound having a cubic crystal phase and represented by Formula 1,
the composite solid electrolyte has a peak at about −2 parts per million (ppm) to about 8 ppm in a ⁷Li nuclear magnetic resonance (NMR) spectrum, and the peak has a full width at half maximum (FWHM) of about 0.3 ppm to about 4.0 ppm,
the lithium haloboracite includes chlorine (Cl), bromine (Br), iodine (I), or a combination thereof, and
the first solid electrolyte has a larger volume than the second solid electrolyte:

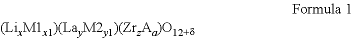

wherein, in Formula 1, M1 is a monovalent cation, a divalent cation, a trivalent cation, or a combination thereof,
M2 is a monovalent cation, a divalent cation, a trivalent cation, a tetravalent, or a combination thereof,

A includes two or more of a monovalent cation, a divalent cation, a trivalent cation, a tetravalent cation, or a pentavalent cation,
6≤x≤8, 0≤x1≤2, 0<y≤4, 0≤y1≤4, 0<z≤3, and 0<a≤3, and
δ is a value determined to satisfy a charge neutrality condition and satisfies −1≤0≤1.

In Formula 1, 6Ax+x1≤8, 2≤y+y1≤4, and 1≤z+a≤3.

In Formula 1, x>x1 and 0<x1≤1.

In Formula 1, y>y1, 0<y≤3, and 0≤y1≤1.

In Formula 1, z<a and 0<z≤0.7.

The composite solid electrolyte may include a compound represented by Formula 2, a compound represented by Formula 2-1, or a combination thereof:

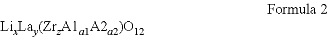

wherein, in Formula 2, A1 is at least one of a monovalent cation, a divalent cation, or a trivalent cation, A2 is at least one of a tetravalent cation or a pentavalent cation, and 6≤x≤8, 0<y≤4, 0<z≤3, 0<a1≤1, 0<a2≤2, and 0<a1+a2≤3,

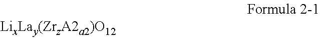

wherein, in Formula 2-1, A2 includes two or more of a tetravalent cation or a pentavalent cation, and 6≤x≤8, 0<y≤4, 0<z≤3, and 0<a2≤3.

In Formula 2, a1<a2, 0<a1≤0.5, and 0<a2≤1.1.

In Formula 2-1, 1≤z+a≤3, z<a2, 0<z≤1, and 0<a2≤1.5.

According to another aspect of the disclosure, a lithium battery includes a cathode, an anode, and an electrolyte layer between the cathode and the anode, wherein at least one of the cathode, the anode, and the electrolyte layer includes a composite solid electrolyte including a first solid electrolyte and a second solid electrolyte, wherein the first solid electrolyte contains a cubic garnet phase, and the second solid electrolyte contains a lithium haloboracite,
wherein the first solid electrolyte includes a compound having a cubic crystal phase and represented by Formula 1, the composite solid electrolyte has a peak at about −2 ppm to about 8 ppm in a ⁷Li nuclear magnetic resonance (NMR) spectrum, and the peak has a full width at half maximum (FWHM) of about 0.3 ppm to about 4.0 ppm, the lithium haloboracite includes chlorine (Cl), bromine (Br), iodine (I), or a combination thereof, and the first solid electrolyte has a larger volume than the second solid electrolyte:

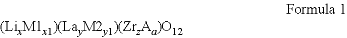

wherein, in Formula 1, M1 is a monovalent cation, a divalent cation, a trivalent cation, or a combination thereof,
M2 is a monovalent cation, a divalent cation, a trivalent cation, a tetravalent, or a combination thereof, A includes two or more of a monovalent cation, a divalent cation, a trivalent cation, a tetravalent cation, or a pentavalent cation, and 6≤x≤8, 0≤x1≤2, 0<y≤4, 0≤y1≤4, 0<z≤3, and 0<a≤3, and δ is a value determined to satisfy a charge neutrality condition and satisfies −130≤1.

The lithium battery may be a lithium-ion battery, a solid battery, or a lithium air battery, and the solid battery may be, for example, a multi-layered ceramic (MLC) battery. The cathode may contain the composite solid electrolyte.

According to another aspect of the disclosure, a method of preparing a composite solid electrolyte includes mixing a first solid electrolyte precursor having an amorphous phase and a second solid electrolyte precursor having a glass phase to prepare a composition for forming a composite solid electrolyte, and heat-treating the composition for forming a composite solid electrolyte,
wherein the method of preparing the composite solid electrolyte includes a first solid electrolyte containing a cubic garnet phase and a second solid electrolyte containing a lithium haloboracite,
the first solid electrolyte is a garnet-containing solid electrolyte including a compound having a cubic crystal phase and represented by Formula 1, the composite solid electrolyte has a peak at about −2 ppm to about 8 ppm in a ⁷Li nuclear magnetic resonance (NMR) spectrum, and the peak has a full width at half maximum (FWHM) of about 0.3 ppm to about 4.0 ppm, the lithium haloboracite includes chlorine (Cl), bromine (Br), iodine (I), or a combination thereof, and the first solid electrolyte has a larger volume than the second solid electrolyte:

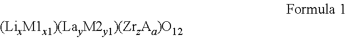

wherein, in Formula 1, M1 is a monovalent cation, a divalent cation, a trivalent cation, or a combination thereof, M2 is a monovalent cation, a divalent cation, a trivalent cation, a tetravalent, or a combination thereof, A includes two or more of a monovalent cation, a divalent cation, a trivalent cation, a tetravalent cation, or a pentavalent cation, and 6≤x≤8, 0≤x1≤2, 0<y≤4, 0≤y1≤4, 0<z≤3, and 0<a≤3, and δ is a value determined to satisfy a charge neutrality condition, and satisfies −130≤1.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A to 1C are views explaining the formation process of a composite solid electrolyte according to an embodiment;

FIG. 1D is a schematic view illustrating the structure of a composite solid electrolyte according to an embodiment;

FIG. 2 is a graph illustrating endothermic heat flow (arbitrary unit, a.u.) versus temperature (Celsius, ° C.) of the results of differential scanning calorimetry (DSC) analysis of an amorphous first solid electrolyte precursor and a glassy second solid electrolyte precursor used in Example 1.

FIG. 3 is a graph illustrating intensity (arbitrary unit, a.u.) versus 2 theta (degree, °) of the X-ray diffraction (XRD) spectra for composite solid electrolytes of Examples 1 to 3 and a solid electrolyte of Reference Example 1, Ref. Garnet, and Ref, Pyrochloro.

FIG. 4 is a graph illustrating changes in ionic conductivity (siemens per centimeters, S/cm) and relative density according to the content of the second solid electrolyte (volume percent, vol %) in the composite solid electrolytes of Examples 1 to 3, a solid electrolyte of Comparative Example 1, and composite solid electrolytes of Comparative Examples 2 and 3;

FIG. 5A is a scanning electron microscope (SEM) photograph of a cross-section of the composite solid electrolyte of Example 1;

FIG. 5B is a SEM photograph of a cross-section of the composite solid electrolyte of Example 3;

FIG. 5C is a SEM photograph of a cross-section of the solid electrolyte of Reference Example 1;

FIGS. 6A to 6F illustrate the results of scanning electron microscope (SEM)-energy dispersive spectroscopy (EDS) analysis of a cross-section of the composite solid electrolyte of Example 1.

FIG. 7 is a graph illustrating intensity (arbitrary unit, a.u.) versus ⁷Li shift (parts per million, ppm) of the ⁷Li-nuclear magnetic resonance analysis spectra for the composite solid electrolytes of Examples 1 and 4 and the solid electrolyte of Comparative Example 2.

FIG. 8 is a schematic cross-sectional view illustrating the structure of a solid battery according to an embodiment;

FIG. 9 is a schematic cross-sectional view illustrating the structure of a solid battery according to an embodiment;

FIG. 10 is a schematic cross-sectional view illustrating the structure of a solid battery according to an embodiment;

FIG. 11 is a schematic perspective view illustrating the structure of a multi-layered ceramic battery according to an embodiment; and

FIG. 12 is a schematic cross-sectional view illustrating the structure of a multi-layered ceramic battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein.

Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept to be described below may undergo various modifications and have various embodiments, and specific embodiments will be illustrated in the drawings and described in detail in the detailed description. However, this is not intended to limit the present inventive concept to a specific embodiment, but should be understood to include all modifications, equivalents or substitutes included in the technical scope of the present inventive concept.

Unless otherwise specified herein, when a part of a layer, film, region, or plate is said to be “over” the other part thereof, this includes not only a case where it is “directly on” the other part, but also a case where it is therebetween or over another part.

Unless otherwise specified herein, singular expression may also include plural expression. Additionally, unless otherwise specified, “A or B” may refer to “including A, including B, or including A and B.”

As used herein, the term “combination thereof” may refer to mixtures, laminates, composites, copolymers, alloys, blends, reaction products, and the like of the components.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

“At least one” is not to be construed as limiting “a” or “an.” “Or” means “and/or.” As used herein, the term “and/or” includes any and all combinations of one or more of the associated listed items.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined herein, the particle diameter may be an average particle diameter. In addition, the particle diameter refers to an average particle diameter (D50), which means the diameter of particles with a cumulative volume of 50% by volume in the particle size distribution. The average particle diameter (D50) may be measured by methods well known to those skilled in the art, for example, by using a particle size analyzer, or by measuring using a transmission electron microscope (TEM) or a scanning electron microscope (SEM). Alternatively, the average particle diameter (D50) may be measured by using a measurement device using dynamic light-scattering. Data analysis may be performed to count the number of particles for each particle size range, and then the average particle diameter (D50) may be calculated from this data analysis. Alternatively, the average particle diameter (D50) may be measured by using a laser diffraction method. In the measurement using the laser diffraction method, more specifically, after the particles to be measured are dispersed in a dispersion medium, they are introduced into a commercially available laser diffraction particle size measurement device (for example, MT 3000, Microtrac Ltd.) and irradiated with ultrasonic waves of about 28 kilohertz (KHz) at an output of 60 watts (W), and then the average particle size (D50) thereof may be calculated based on 50% of the particle size distribution in the measurement device.

The terms to be used below are used only to describe specific embodiments and are not intended to limit the present inventive concept. Singular expressions include plural expressions unless the context clearly indicates otherwise. Hereinafter, the terms “include” or “have” and the like are intended to indicate the presence of a feature, number, step, operation, component, part, ingredient, material or combination thereof described in the specification, but should be understood to not exclude in advance the possibility of the presence or addition of one or more other features, numbers, steps, operations, components, parts, ingredients, materials or combinations thereof. The “/” to be used below may be interpreted as either “and” or “or” depending on the situation.

To clearly express the various layers and regions in the drawing, the thickness is enlarged or reduced. Similar parts are designated by the same reference numerals throughout the specification. When a part, such as a layer, film, region, or plate, is said to be “on” or “over” another part throughout the specification, this case includes not only a case where it is directly on the other part, but also a case where there are other parts therebetween. Throughout the specification, the terms “first”, “second”, etc. may be used to describe various components, but the components should not be limited by the terms. The terms are used only to distinguish one component from other components.

As used herein, the “metals” include both metals and metalloids such as silicon and germanium, in an elemental state or an ionic state.

As used herein, the “cathode active material” refers to a cathode material capable of undergoing lithiation and delithiation, and the “anode active material” refers to an anode material capable of undergoing lithiation and delithiation.

As used herein, the “lithiation” or “lithiating” refers to a process of adding lithium to a cathode active material or an anode active material, and the “delithiation” or “delithiating” refers to a process of removing lithium from a cathode active material or an anode active material.

As used herein, the “charging” or “charge” refers to a process of providing electrochemical energy to a battery, and the “discharging” or “discharge” refers to a process of removing electrochemical energy from the battery.

As used herein, the “positive electrode” or “cathode” refers to an electrode where electrochemical reduction and lithiation occur during a discharge process, and the “negative electrode” or “anode” refers to an electrode where electrochemical oxidation and delithiation occur during the discharge process.

As used herein, the “particle diameter” of a particle refers to an average diameter when the particle is spherical, and refers to an average major axis length when the particle is non-spherical. The particle diameter may be measured using a particle size analyzer (PSA). The “particle diameter” of a particle is, for example, an average particle diameter. The average particle diameter is a median particle diameter (D50) unless otherwise explicitly stated. The median particle diameter (D50) is a size of the particle corresponding to the cumulative value of 50%, calculated from the side of the particle having the smallest particle size in the cumulative distribution curve of particle sizes in which particles accumulate in order of particle size from the smallest particle to the largest particle. The cumulative value may be, for example, a cumulative volume. The median particle diameter (D50) may be measured, for example, by a laser diffraction method.

When measuring a particle size using a scanning electron microscope, it is determined as an average value of 30 or more randomly selected particles of 1 micrometers (μm) or more, excluding fine particles.

The average particle diameter of the cathode active material may be measured, for example, by using a laser diffraction method. More specifically, after the cathode active material is dispersed in a solution, this material is introduced into a commercially available laser diffraction particle size measurement device (for example, MT 3000, Microtrac Ltd.) and irradiated with ultrasonic waves of about 28 KHz at an output of 60 W, and then the average particle diameter (D50) may be calculated based on 50% of the particle size distribution in the measurement device.

As used herein, the term “D10” refers to an average diameter of particles having a cumulative volume of 10% by volume in a particle size distribution, and “D90” refers to an average diameter of particles having a cumulative volume of 90% by volume in the particle size distribution.

As used herein, the thickness refers to an average thickness, and may be confirmed using a scanning electron microscope or a transmission electron microscope.

Hereinafter, a composite solid electrolyte according to an embodiment, a method for preparing the composite solid electrolyte, and a lithium battery including the composite solid electrolyte will be described in more detail.

When manufacturing an all-solid-state battery using a sodium super ionic conductor (NASICON) solid electrolyte, a sintering temperature is high (about 700° C.) and a reduction potential window is low, thereby limiting an electrode active material and reducing cell energy density. Accordingly, a method of manufacturing an all-solid-state battery using a glass solid electrolyte instead of the NASICON solid electrolyte was proposed. However, although this glass solid electrolyte can utilize various electrode active materials, the conductivity of the glass solid electrolyte is low, and thus improvement is required.

A garnet-containing oxide solid electrolyte has high room-temperature conductivity, but high-temperature sintering is required for interparticle connection due to hard oxide material properties. However, when this high-temperature sintering process is performed, a secondary phase with high resistance may be made by reacting with an active material, or each of the active material and electrolyte itself may deteriorate. Therefore, in order to apply an oxide-containing solid electrolyte, it is necessary to lower heat treatment temperature, which is a process temperature, to a level at which it does not react with the active material. However, when the heat treatment temperature is lowered in this way, the ionic conductivity of the garnet-containing oxide solid electrolyte decreases significantly due to insufficient interparticle connection. Therefore, it is required to maintain the high conductivity characteristics of a garnet-containing crystalline electrolyte by adding a material capable of forming an interface at low temperatures.

To solve the above-described problems, there is provided a composite solid electrolyte that can be sintered at a lower temperature than the garnet-containing oxide solid electrolyte, has high conductivity, and has improved relative density. When using such a composite solid electrolyte, side reactions with the electrode active material do not occur, so various electrode active materials can be used.

### Composite Solid Electrolyte

A composite solid electrolyte according to an embodiment includes a first solid electrolyte containing a cubic garnet phase, and a second solid electrolyte containing a lithium haloboracite, wherein the first solid electrolyte is a garnet-containing solid electrolyte including a compound having a cubic crystal phase and represented by Formula 1, and the composite solid electrolyte has a peak at about −2 ppm to about 8 ppm in a ⁷Li nuclear magnetic resonance (NMR) spectrum, and the peak has a full width at half maximum (FWHM) of about 0.3 ppm to about 4.0 ppm. The first solid electrolyte has a larger volume than the second solid electrolyte, and the lithium haloboracite includes chlorine (Cl), bromine (Br), iodine (I), or a combination thereof.

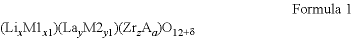

wherein, in Formula 1, M1 is a monovalent cation, a divalent cation, a trivalent cation, or a combination thereof,
M2 is a monovalent cation, a divalent cation, a trivalent cation, a tetravalent, or a combination thereof,

A includes two or more of a monovalent cation, a divalent cation, a trivalent cation, a tetravalent cation, or a pentavalent cation, 6≤x≤8, 0≤x1≤2, 0<y≤4, 0≤y1≤4, 0<z≤3, and 0<a≤3, and

δ is a value determined to satisfy a charge neutrality condition, is determined by the oxidation number and element ratio of the elements constituting each compound, and is in a range of −1≤0≤1.

In all formulas of this specification, O₁₂ may be O_{12+δ}.

In Formula 1, 0 may be, for example, 0.

In Formula 1, A may include three or more elements selected from a monovalent cation, a divalent cation, a trivalent cation, a tetravalent cation, and a pentavalent cation.

As can be seen in Formula 1, the first solid electrolyte contains a compound in which zirconium is substituted with two or more types of multi-elements, thereby increasing the deformable properties and forming a composite solid electrolyte having a high relative density and a crystalline garnet structure through low-temperature heat treatment to have high ionic conductivity characteristics.

In Formula 1, 6≤x+x1≤8, 0≤y+y1≤4, 0<z+a≤3, or 6≤x+x1≤8, 2≤y+y1≤4, 1≤z+a≤3. In Formula 1, 6.5≤x+x1≤7.5, 0≤y+y1≤3.5, and 0<z+a≤2.5.

In Formula 1, x>x1 and 0<x1≤1. In Formula 1, y>y1, 0<y≤3, 0≤y1≤2, 0≤y1≤1, or 0≤y1<1.

In Formula 1, z<a, 0<z≤0.7, or 0.4≤z≤0.67. In Formula 1, 1.3≤a≤1.6, 1.33≤a≤1.6, or 1.5≤a≤1.6.

In Formula 1, 6.5≤x+x1≤7.5, 0≤y+y1≤3.5, and 0<z+a≤2.5.

In Formula 1, 0≤y1<4, 0≤y1≤3, 0≤y1≤2, 0≤y1≤1, or 0≤y1<1.

In Formula 1, 0<a≤3, 0<a≤2.5, 0<a≤2, 0<a≤2.5, 0<a≤1, 0<a≤0.5, 0<a≤0.9, 0<a≤0.85, 0<a≤0.8, 0<a≤0.85, 0<a≤0.7, 0<a≤0.75, 0<a≤0.6, 0<a≤0.65, 0<a≤0.5, 0<a≤0.55, 0<a≤0.4, 0<a≤0.45, 0<a≤0.3, 0<a≤0.35, 0<a≤0.2, 0<a≤0.25, 0<a≤0.15, 0<a≤0.1, 0<a≤0.05, or 0<a≤0.01. A may include three or more of a monovalent cation, a divalent cation, a trivalent cation, a tetravalent cation, or a pentavalent cation.

According to an embodiment, in Formula 1, x>x1 and 0<x1≤1.

In Formula 1, y>y1, 0<y≤3, 0≤y1≤1. In Formula 1, z<a, 0<z≤0.7, 0<a≤3.

The FWHM of the peak of ⁷Li NMR of the composite solid electrolyte may be about 0.5 ppm to about 3.5 ppm, about 0.8 ppm to about 3.5 ppm, about 1.0 ppm to about 3.5 ppm, about 2.0 ppm to about 3.0 ppm, about 2.1 ppm to about 2.8 ppm, about 2.2 ppm to about 2.6 ppm, about 2.2 ppm to about 2.5 ppm, about 2.21 ppm to about 2.5 ppm, about 2.21 ppm to about 2.4 ppm, or about 2.21 ppm to about 2.3 ppm. The FWHM within the above range may be due to the overall formation of a disordered local structure in the solid electrolyte.

In Formula 1, M1, M2 and A may be different elements from each other.

In Formula 1, the monovalent cation includes at least one of lithium (Li), sodium (Na), or potassium (K). The divalent cation to the pentavalent cation may include, for example, at least one of magnesium (Mg), calcium (Ca), strontium (Sr), Sc, yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), tholium (Tm), ytterbium (Yb), lutetium (Lu), zirconium (Zr), hafnium (Hf), vanadium (V), niobium (Nb), tantalum (Ta), molybdenum (Mo), tungsten (W), manganese (Mn), technetium (Tc), rhenium (Re), iron (Fe), ruthenium (Ru), osmium (Os), cobalt (Co), or rhodium (Rh), It may include at least one of iridium (Ir), nickel (Ni), palladium (Pd), platinum (Pt), copper (Cu), silver (Ag), gold (Au), zinc (Zn), Cd, Hg, aluminum (Al), gallium (Ga), indium (In), thallium (Tl), germanium (Ge), tin (Sn), lead (Pb), antimony (Sb), bismuth (Bi), polonium (Po), arsenic (As), selenium (Se), or tellurium (Te).

In Formula 1, M1 may include at least one of, for example, sodium (Na), potassium (K), gallium (Ga), or aluminum (Al).

In Formula 1, M2 may include at least one of, for example, calcium (Ca), strontium (Sr), cesium (Ce), or barium (Ba).

In Formula 1, A may be, for example, sodium (Na), potassium (K), calcium (Ca), magnesium (Mg), gallium (Ga), aluminum (Al), indium (In), scandium (Sc), niobium (Nb), tantalum (Ta), antimony (Sb), tin (Sn), hafnium (Hf), tungsten (W), tellurium (Te), or a combination thereof.

In Formula 1, x1=0 and/or y1=0.

In Formula 1, 6.1≤x≤8, 6.3≤x≤7.9, 6.5≤x≤7.7, or 6.7≤x≤7.5.

In Formula 1, 0≤x1≤2, 0.5≤x1≤1.8, 0.7≤x1≤1.8, or 1≤x1≤2.

In Formula 1, 2≤y≤3, 2.3≤y≤3, 2.5≤y≤3, or 2.7≤y≤3.

In Formula 1, 0≤x2≤1, 0.3≤x2≤1, 0.5≤x2≤1, or 0.7≤x2≤1,

In Formula 1, 0<z≤2, 0.3≤z≤2, 0.5≤z≤1.8, or 0.7≤z≤1.6, In Formula 1, 0≤a≤2, 0.1≤a≤2, 0.3≤a≤2, 0.5≤a≤2, or 0.7≤a≤2.

The first solid electrolyte according to an embodiment may include a compound represented by Formula 2, a compound represented by Formula 2-1, or a combination thereof:

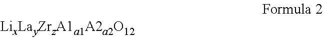

wherein, in Formula 2, A1 is at least one of a monovalent cation, a divalent cation, or a trivalent cation, A2 is at least one of a tetravalent cation or a pentavalent cation, and 6≤x≤8, 0<y≤4, 0<z≤3, 0<a1≤1, 0<a2≤2, and 0<a1+a2≤3,

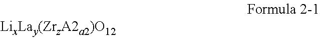

wherein Formula 2-1, A2 includes two or more of a tetravalent cation or a pentavalent cation, and 6≤x≤8, 0<y≤4, 0<z≤3, and 0<a2≤3.

In Formula 2, A1 and A2 may substitute for some sites of Zr, and in Formula 2-1, A2 may substitutes for some sites of Zr.

In Formulas 2 and 2-1, A1 may be at least one of sodium (Na), potassium (K), calcium (Ca), magnesium (Mg), gallium (Ga), aluminum (Al), indium (In), scandium (Sc), or a combination thereof, and A2 may include at least two of tin (Sn), hafnium (Hf), niobium (Nb), tantalum (Ta), or antimony (Sb).

In Formulas 2 and 2-1, A1 may be Sc, and A2 may include two or more of Sn, Hf, or Ta.

In Formulas 2 and 2-1, A2 may include Ta, and further include at least one of Sn, Hf, Nb, Ta, or Sb.

According to an embodiment, in Formula 2, 6≤x≤8, 2≤y≤4, 0<a1≤1, 0<z≤3, 0<a2≤2, and 0<a1+a2≤3.

In Formula 2, a1≤a2, or a1<a2.

In Formula 2, a1<a2, 0<a1≤0.5, and 0<a2≤1.1.

In Formula 2, z<a1+a2, 0<z≤0.7, or 0.4≤z≤0.67.

In Formula 2, 1.3≤a1+a2≤1.6, 1.33≤a1+a2≤1.6, or 1.5≤a1+a2≤1.6.

In Formulas 2 and 2-1, for example, 2≤y≤4 and 1≤z≤3.

In Formula 2-1, 1≤z+a≤3, z<a2, 0<z≤1, and 0<a2≤1.5.

The compound of Formula 1 may include, for example, a compound represented by Formula 3:

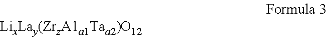

wherein, in Formula 3, A1 includes two or more of Na, K, Ca, Mg, Ga, Al, In, Sc, or a combination thereof, and 6≤x≤8, 0<y≤4, 0<z≤3, 0<a1≤1, and 0<a2≤2.

In Formula 3, 6≤x≤8, 2≤y≤4, 0<a1≤1, 0<z≤3, 0<a2≤2, and 0<a1+a2≤3.

In Formula 3, z<a1+a2, 0<z≤0.7, or 0.4≤z≤0.67.

In Formula 3, 1.3≤a1+a2≤1.6, 1.33≤a1+a2≤1.6, or 1.5≤a1+a2≤1.6.

In Formula 3, 2≤y≤4 and 1≤z≤3.

The compound of Formula 2 may include a compound of Formula 4, a compound of Formula 5, or a combination thereof:

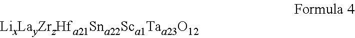

wherein, in Formula 4, 6≤x≤8, 2≤y≤4, 1≤z≤3, 0<a1≤1, 0<a21≤0.75, 0<a22≤0.75, 0<a23≤1.5, a21+a22+a23=a2, and 0<a2≤2,

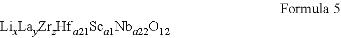

wherein, in Formula 5, 6≤x≤8, 0<y≤4, 0<z≤3, 0<a1≤1, 0<a21≤1.5, 0<a22≤1.5, a21+a22=a2, and 0<a2≤3.

In Formulas 4 and 5, 2≤y≤4 and 1≤z≤3.

In Formula 4, z<a21+a22+a1+a23, 0<z≤0.7, or 0.4≤z≤0.67.

In Formula 4, 1.3≤a21+a22+a1+a23≤1.6, 1.33≤a21+a22+a1+a23≤1.6, or 1.5≤a21+a22+a1+a23≤1.6.

In Formula 5, z<a21+a22+a1, 0<z≤0.7, or 0.4≤z≤0.67.

In Formula 5, 1.3≤a21+a22+a1≤1.6, 1.33≤a21+a22+a1≤1.6, or

1.5≤a21+a22+a≤1.6.

The compound of Formula 1 according to an embodiment may include, for example, Li_{6.5}La₃Zr_{0.4}Hf_{0.4}Sn_{0.4}SC_{0.15}Ta_{0.65}O₁₂, Li_{6.5}La₃Zr_{0.4}Hf_{0.4}Sn_{0.4}In_{0.15}Nb_{0.65}O₁₂, Li₇La₃Zr_{0.4}Hf_{0.4}Sn_{0.4}SC_{0.4}Ta_{0.4}O₁₂, Li₇La₃Zr_{0.5}Hf_{0.5}Sc_{0.5}Nb_{0.5}O₁₂, Li_{6.5}La₃Zr_{2/3}Hf_{2/3}Sn_{2/3}O₁₂, or a combination thereof.

In the composite solid electrolyte according to an embodiment, lithium haloborasite may contain a crystal phase, and lithium haloborasite may include, for example, lithium chloroborasite, lithium bromoborasite, lithium iodoborasite, or a combination thereof. The composition of lithium haloborasite may be confirmed through elemental analysis.

The composite solid electrolyte may include a first solid electrolyte having a cubic garnet phase and a second solid electrolyte including a lithium haloboracite obtained by sintering an amorphous first solid electrolyte precursor containing various cation elements and a second solid electrolyte precursor having a glass phase. The solid electrolyte precursor having an amorphous phase and containing various cation elements has soft and deformable properties, and when using this solid electrolyte precursor, a composite solid electrolyte having high ionic conductivity as well as relative density characteristics can be used while ensuring densification through low-temperature heat treatment.

The sintering temperature of the composite solid electrolyte is higher than the crystallization temperature of the first solid electrolyte and the crystallization temperature of the second solid electrolyte. When using this composite solid electrolyte, a lithium battery having improved energy density and capable of low-temperature sintering at a temperature of 600° C. or lower can be manufactured. A lithium battery having improved cycle characteristics can be provided by using such a composite solid electrolyte.

The composite solid electrolyte according to an embodiment may further include a pyrochlore phase.

The first solid electrolyte according to an embodiment may further include a pyrochlore phase.

The first solid electrolyte has high relative density and high conductivity, and the second solid electrolyte has excellent deformability.

When Interparticle connection is made through the crystallization process of the first solid electrolyte in an amorphous state and the second solid electrolyte precursor having a glass phase is filled between the first solid electrolytes or is crystallized through subsequent heat treatment, the interfacial resistance between particles is reduced, thereby manufacturing a composite solid electrolyte having improved ionic conductivity and high relative density.

The crystallization temperature of the first solid electrolyte is lower than the crystallization temperature of the second solid electrolyte, and the heat treatment temperature, that is, sintering temperature of the composition for forming a composite solid electrolyte containing the first solid electrolyte precursor having an amorphous phase and the second solid electrolyte precursor having a glass phase is higher than the crystallization temperature of the first solid electrolyte and the crystallization temperature of the second solid electrolyte.

The heat treatment temperature, that is, sintering temperature (T) of a mixture of the first solid electrolyte precursor and second solid electrolyte precursor for preparing the composite solid electrolyte is 600° C. or lower, or 550° C. or lower, and the crystallization temperature (T1) of the first solid electrolyte, the heat treatment temperature, that is, sintering temperature (T) of the composition for forming the composite solid electrolyte, and the crystallization temperature (T2) of the second solid electrolyte satisfy Expression 1:

### Expression 1

the crystallization temperature of the first solid electrolyte (T1)<the crystallization temperature of the second solid electrolyte (T2)<the heat treatment temperature of the composition for forming a composite solid electrolyte (T).

The heat treatment temperature, that is, sintering temperature (T), of the mixture of the first solid electrolyte precursor and second solid electrolyte precursor for preparing the composite solid electrolyte may be 600° C. or lower, 550° C. or lower, about 350° C. to about 550° C., about 380° C. to about 550° C., about 400° C. to about 550° C., or about 450° C. to about 550° C. The heat treatment time of the mixture of the first solid electrolyte and the second solid electrolyte varies depending on the heat treatment temperature, but is, for example, about 10 minutes to about 2 hours. The crystallization temperature (T1) of the first solid electrolyte may be about 300° C. to about 450° C., about 350° C. to about 430° C., or about 380° C. to about 420° C., and the crystallization temperature (T2) of the second solid electrolyte may be about 450° C. to about 550° C., higher than 450° C. and 550° C. or lower, higher than 450° C. and 520° C. or lower, or higher than 450° C. and 500° C. or lower.

When the crystallization temperature (T1) and sintering temperature (T) of the first solid electrolyte and the crystallization temperature (T2) of the second solid electrolyte are within the above ranges, a composite solid electrolyte having improved low-temperature sintering properties and ionic conductivity can be prepared.

In the composite solid electrolyte according to an embodiment, the lithium haloboracite of the second solid electrolyte may have a crystalline phase, a glass phase, or both. For example, the lithium haloboracite of the second solid electrolyte may have a structure including 100 weight percent (wt %) of a crystal phase. Alternatively, the lithium haloboracite of the second solid electrolyte may have a structure including a crystal phase and a glass phase. Alternatively, the lithium haloboracite of the second solid electrolyte may have a structure including 100 wt % of a glass phase.

The lithium haloboracite of the second solid electrolyte may have a glass-ceramic structure including a ceramic phase (crystal phase) as a main phase and a glass phase as a minor phase. Here, the content of the glass phase as minor phase may be 5 wt % or less, 1 wt % or less, or about 0.001 wt % to about 1 wt % based on the total weight of the lithium haloboracite.

In this specification, the “glass” refers to an amorphous material exhibiting a glass transition phenomenon. Further, the “glass-ceramic” refers to a material in which an amorphous material and one or more crystalline material are mixed, and is a material in which two components of a glass phase (amorphous phase) and a ceramic phase (crystalline phase) are observed.

The second solid electrolyte includes lithium haloborasite containing a crystal phase and may have a high ionic conductivity (25° C., 1 atmosphere (atm)) of 1×10⁻⁶ siemens per centimeter (S/cm) or more, or about 1×10⁻⁶ S/cm to about 1×10⁻³ S/cm, thereby improving the ionic conductivity of the composite solid electrolyte.

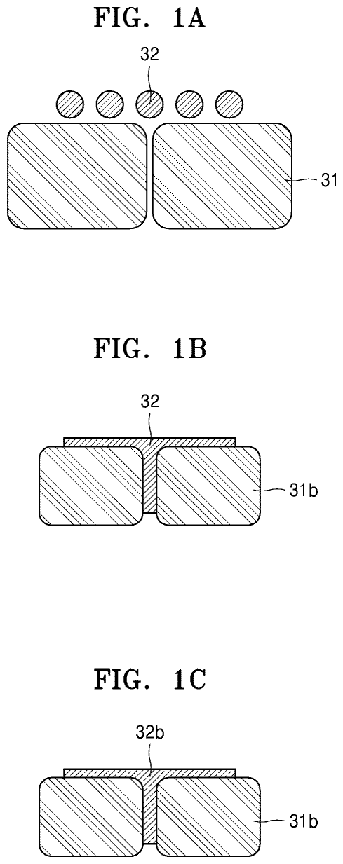

Hereinafter, a process of forming a composite solid electrolyte according to an embodiment will be described in detail with reference to FIGS. 1A to 1D.

An amorphous first solid electrolyte precursor 31 and a glassy second solid electrolyte precursor 32 are mixed to prepare a composition for forming a composite solid electrolyte. FIG. 1A shows a state of the amorphous first solid electrolyte precursor 31 and the glassy second solid electrolyte precursor 32 before the crystallization temperature of the first solid electrolyte precursor.

When the first solid electrolyte precursor 31 is heat-treated at crystallization temperature or higher, as shown in FIG. 1B, the amorphous first solid electrolyte precursor 31 is crystallized and converted into a high-conductivity first solid electrolyte 31b having a cubic garnet crystal phase. The amorphous first solid electrolyte precursor 31 and the high-conductivity first solid electrolyte 31b having a cubic garnet crystal phase have different densities from each other, so that a volume change occurs and pores are formed when first solid electrolyte precursor 31 is crystallized. The high-conductivity first solid electrolyte 31b may further include a pyrochlore phase.

The second solid electrolyte precursor 32 having a glass phase has fluidity and thus fill pores as shown in FIG. 1B, thereby improving the relative density of a composite solid electrolyte. The second solid electrolyte precursor 32 includes a halogen atom such as chlorine, fluorine, or iodine and thus has an ionic conductivity of 1×10⁻⁶ S/cm or more, which is relatively high compared to other glass materials when crystallized, thereby contributing to the high ionic conductivity of a composite solid electrolyte. Further, the second solid electrolyte precursor 32 has almost no difference in density between the amorphous phase and the crystalline phase, so that pores can be minimized during crystallization.

Referring to FIG. 1C, when the temperature of the second solid electrolyte rises to the crystallization temperature of the second solid electrolyte, a composite solid electrolyte including a high-conductivity first solid electrolyte 31b having a cubic garnet crystal phase and a second solid electrolyte 32b containing a crystal phase is formed.

According to another embodiment, a composite solid electrolyte 3 contains a high-conductivity first solid electrolyte 1 having a cubic garnet crystal phase and a second solid electrolyte 2 having lithium haloborasite containing a crystal phase. In the disclosure, the high-conductivity first solid electrolyte 1 may further includes a pyrochlore phase.

The second solid electrolyte 2 has flexibility, and thus connects particles of the first solid electrolyte 1 or fills pores. By having such a structure, a composite solid electrolyte having both high conductivity and density and having high relative density can be prepared.

In the composite solid electrolyte according to an embodiment, the content of the first solid electrolyte is more than 50 volume percent (vol %) and 99 vol % or less, about 60 vol % to about 98 vol %, about 70 vol % to about 97 vol %, or about 80 vol % to about 95 vol %, based on the total volume of the composite solid electrolyte (total volume of the first solid electrolyte and the second solid electrolyte).

In the composite solid electrolyte according to an embodiment, the content of the second solid electrolyte is less than 50 vol %, about 1 vol % to about 45 vol %, about 5 vol % to about 45 vol %, or about 5 vol % to about 20 vol %, based on the total volume of the composite solid electrolyte. The mixing volume ratio of the first solid electrolyte and the second solid electrolyte is about 99:1 to about 55:45 (1.2:1), about 95:5 (19:1) to about 60:40 (1.5:1), or about 95:5 (19:1) to about 80:20 (4:1). When the content of the second solid electrolyte is more than 50 vol %, there is a limit to the improvement in the ionic conductivity of the composite solid electrolyte.

When the content of the second solid electrolyte is within the above range, a composite solid electrolyte capable of being sintered at a low temperature and having a high room-temperature conductivity of 1×10⁻⁵ S/cm or more, 1×10⁻⁵ S/cm to 1×10⁻³ S/cm, or 2.4×10⁻⁵ S/cm to 1×10⁻³ S/cm can be prepared.

The average particle size of the amorphous first solid electrolyte precursor before heat treatment of the first solid electrolyte may be about 10 nanometers (nm) to about 1 μm. The average crystal size of the first solid electrolyte after heat treatment may have a range of about 50 nm to about 50 μm, about 100 nm to about 30 μm, or about 500 nm to about 20 μm. In this way, as the crystal size of the sintered body obtained by heat treatment increases, the ionic conductivity of the composite solid electrolyte increases. Here, when the crystal phase of the first solid electrolyte is spherical, the average size of the crystal phase refers to an average diameter of the crystal phase, and when the crystal phase of the first solid electrolyte is non-spherical, the average size of the crystal phase refers to an average major axis length of the crystal phase. The average size of the crystal phase of the first solid electrolyte may be evaluated through an electron scanning microscope image.

The relative density of the composite solid electrolyte may be about 90% to about 99.5%, about 90% to about 99.5%, or about 91.5% to about 99.1%. When the relative density of the composite solid electrolyte is within the above range, the compactness thereof is excellent, so that a lithium battery having improved charge-discharge characteristics can be manufactured by using this composite solid electrolyte.

The thickness of the composite solid electrolyte may be about 0.1 μm to about 500 μm, about 0.5 μm to about 300 μm, about 1 μm to about 300 μm, about 1 μm to about 200 μm, about 3 μm to about 200 μm, about 5 μm to about 200 μm, or about 3 μm to about 20 μm. When the thickness of the composite solid electrolyte is within the above range, a lithium battery having excellent charge-discharge characteristics can be manufactured. In this disclosure, the thickness refers to an average thickness.

The composite solid electrolyte according to an embodiment may have a porosity of about 0.5% to about 20% or about 0.5% to about 10% and an average pore size of about 100 nm to about 1000 nm or about 100 nm to about 500 nm. The composite solid electrolyte having such porosity and average pore size ensures conductivity and density at low temperatures and improves relative density characteristics. When using such a composite solid electrolyte, a lithium battery capable of low-temperature sintering and having improved energy density and cycle characteristics may be provided. In the disclosure, the average pore size can be evaluated through a scanning electron microscope image.

The degree of crystallinity of the composite solid electrolyte may be about 90% to about 100%, about 93% to about 100%, or about 95% to about 100%. When using the composite solid electrolyte having such a degree of crystallinity, a lithium battery capable of low-temperature sintering and having improved energy density and cycle characteristics may be provided.

As can be seen from Formula 1, the first solid electrolyte may include a material including two or more (A) of Li, La, Zr, a monovalent cation, a divalent cation, a trivalent cation, a tetravalent cation, a pentavalent cation, or O. The second solid electrolyte precursor may include a glass-containing material having a glass transition phenomenon, for example, Li, B, Al, CI, or O. The content of lithium in the first solid electrolyte may be higher than the content of lithium in the second solid electrolyte precursor.

The heat treatment of the first solid electrolyte precursor and second solid electrolyte precursor for preparing a composite solid electrolyte may be performed at a temperature range higher than the crystallization temperature of the first solid electrolyte and the crystallization temperature of the second solid electrolyte. After heat treatment in this temperature range, the composite solid electrolyte includes a first solid electrolyte including a cubic garnet phase and a second solid electrolyte containing a crystal phase. The first solid electrolyte may contain, for example, a cubic garnet phase as a main phase and partially contain a pyrochlore phase.

A composite solid electrolyte according to an embodiment may include a garnet-type crystal phase.

The composite solid electrolyte may further include a pyrochlore phase.

In the XRD spectrum of the composite solid electrolyte according to an embodiment, peaks may appear at diffraction angles 2 theta (20)=16.8°+0.5°, 2θ=17.5° to 19°, 2θ=26° to 28°, 2θ=32° to 33°, 2θ=46° to 48°, 2θ=27.5° to 29°, 2θ=32° to 33.5°, 20=46.5° to 48°, and 20=55° to 56.5°. Here, the peaks appearing in the regions of diffraction angles 2θ=16.8°+0.5°, 2θ=17.5° to 19°, 2θ=26° to 28°, 2θ=33° to 33°, and 20=46° to 48° are peaks related to a cubic garnet phase, and the peaks appearing in the regions of 20=27.5° to 29°, 2θ=32° to 33.5°, 2θ=46.5° to 48°, and 20=55° to 56.5° are peaks related to a pyrochlore phase.

The composite solid electrolyte according to an embodiment may be in a state of absence of a tetragonal phase. In this state, the peak at the diffraction angle 20=16.8°+0.5° in the XRD spectrum of the solid electrolyte may have a singlet shape.

As described above, the composite solid electrolyte according to an embodiment has improved deformation characteristics and can thus be formed into various shapes at low temperatures. In addition, since the low-temperature forming of the composite solid electrolyte is possible, deformation of a structure is reduced when combined with a structure such as an electrode, and the composite solid electrolyte also has a high relative density and densified characteristics, and the interface characteristics of a solid electrolyte and a structure such as an electrode can be stabilized.

The content of cubic garnet crystal phase in composite solid electrolytes can be confirmed directly or indirectly through XRD analysis or transmission electron microscope/selected area electron diffraction (TEM/SAED) analysis. Through XRD analysis, a dominantly maintained crystal phase may be selected, and then XRD Rietveld analysis may be performed to determine the mixing ratio of each crystal phase. In addition, when the composite solid electrolyte contains a pyrochlore phase, the pyrochlore phase may be directly or indirectly confirmed through XRD analysis or TEM/SAED analysis.

The composite solid electrolyte according to an embodiment may include a cubic garnet phase and a lithium haloboracite, thereby facilitating lithium transfer within the solid electrolyte compared to a solid electrolyte containing only a cubic garnet phase.

The composite solid electrolyte according to an embodiment may not include a pyrochlore phase.

The composite solid electrolyte according to an embodiment may include a cubic garnet phase as a crystal phase. When the composite solid electrolyte may include a pyrochlore phase, the content of the cubic garnet phase may be 60 wt % or more, 70 wt % or more, 80 wt % or more, about 80 wt % to about 99 wt %, or about 90 wt % to about 99.5 wt % based on the total content of the cubic garnet phase and the pyrochlore phase, and the remainder is a phase that does not include lithium, such as a pyrochlore phase. For example, the pyrochlore phase may be La₂₊ₓZr₂₍₁₋ₓ₎TaₓO₇ (0≤x≤0.5). The content of the pyrochlore phase may be about 0.5 wt % to about 10 wt %, about 1 wt % to about 5 wt %, or about 1 wt % to about 3 wt % based on the total content of the cubic garnet phase and the pyrochlore phase.

When the content of the cubic garnet phase is within the above range, the ionic conductivity of the composite solid electrolyte is very excellent. If the content of the cubic garnet phase is within the above range, a solid electrolyte having high ionic conductivity in various temperature ranges and low interfacial resistance with a cathode or an anode when manufacturing a lithium battery can be obtained.

The ionic conductivity of the composite solid electrolyte according to an embodiment at 25° C. and 1 atm may be 1×10⁻⁶ S/cm or more, about 1×10⁻⁶ S/cm to about 1×10⁻³ S/cm, or about 2.4×10⁻⁶ S/cm to about 1×10⁻³ S/cm, and has a densified characteristic without going through a high-temperature sintering process, so that the composite solid electrolyte has a high relative density of 95% or more, for example, about 95% to about 99.9%. In this specification, the “relative density” means a density calculated by measuring the dimensions (diameter and thickness) and mass of a sintered body. In addition, the relative density may be obtained by using a pycnometer and a theoretical density of lithium lanthanum zirconium oxide (LLZO) (5.14 grams per cubic centimeter (g/cm³)).

The composite solid electrolyte according to an embodiment can be electrochemically stable at a voltage of 3.0 volts (V) or higher, for example, about 3.0 V to about 4.5 V, versus lithium metal.

The second solid electrolyte is a lithium ion conductor of oxide glass containing chlorine, and has relatively high ionic conductivity compared to other glass-containing materials that do not contain chlorine, thereby allowing the composite solid electrolyte to maintain high ion conductivity.

The second solid electrolyte may include, for example, a compound represented by Formula 6:

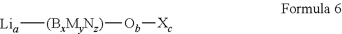

wherein, in Formula 6, a may be a number of 4 to 7, b may be a number of 12 to 13,
c may be a number of greater than 0 and equal to 1, 0<x≤7, 0≤y≤3, 0≤z≤1, and 6≤x+y+z≤7,
M and N may be each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W, and
X may be CI, Br, I, or a combination thereof.

The second solid electrolyte may include a compound represented by Formula 6-1:

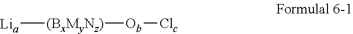

wherein, in Formula 6-1, a may be a number of 4 to 7, b may be a number of 12 to 13, c may be a number of more than 0 and 1 or less, 0<x≤7, 0≤y≤3, 0≤z≤1, and 6≤x+y+z≤7, and M and N may be each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W.

M is, for example, Al, Ga, or a combination thereof, and N may be selected differently from M, for example, Fe.

4≤x≤7 or 5≤x≤7, and O≤y≤3 or 0≤y≤1.

The second solid electrolyte may include, for example, Li₄B₇O₁₂CI, Li₄B₄Al₃O₁₂CI, Li₄B₄Ga₃O₁₂CI, Li₄B₅AlFeO₁₂CI, or a combination thereof.

Method of preparing composite solid electrolyte

A method of preparing a composite solid electrolyte may include: mixing a first solid electrolyte precursor having an amorphous phase and a second solid electrolyte precursor having a glass phase to prepare a composition for forming a composite solid electrolyte; and heat-treating the composition for a composite solid electrolyte.

The heat treatment may be performed within a temperature range higher than the crystallization temperature of the first solid electrolyte and the crystallization temperature of the second solid electrolyte. For example, the heat treatment of the composition for forming a composite solid electrolyte may be performed at 600° C. or lower, or 550° C. or lower. The heat treatment of the composition for forming a composite solid electrolyte may be performed at, for example, about 350° C. to about 550° C., about 380° C. to about 550° C., about 400° C. to about 550° C., or about 450° C. to about 550° C.

During the heat treatment process, the amorphous first solid electrolyte precursor is crystallized to become a first solid electrolyte having a cubic garnet phase, and the glassy second solid electrolyte precursor has fluidity to connect the first solid electrolyte particles having a crystal phase because the glass transition temperature of the second solid electrolyte precursor is in a range near the crystallization temperature of the first solid electrolyte. In addition, the pores formed when the first solid electrolyte is crystallized may be filled with the second solid electrolyte precursor having fluidity, and the second solid electrolyte in the finally obtained composite solid electrolyte has a structure containing a crystal phase, so that the composite solid electrolyte may include a composite crystal phase structure. In addition, since the composite solid electrolyte according to an embodiment includes crystal particles of the first solid electrolyte formed during the preparation process, the composite solid electrolyte may include crystal particles having a smaller size than a commercially available crystal first solid electrolyte. When the first solid electrolyte precursor having an amorphous phase is crystallized, a close interface with the second solid electrolyte may be formed. Accordingly, the composite solid electrolyte according to an embodiment may have improved conductivity and density.

The second solid electrolyte precursor exhibits a glass transition phenomenon, and has a glass transition temperature of 450° C. or lower, for example, about 350° C. to about 450° C. The above-described glass transition phenomenon may be confirmed through differential scanning calorimetry analysis. Since the second solid electrolyte precursor has the above-described glass transition temperature range, it has excellent deformability during the pressurized heat treatment process and can increase the relative density of the composite solid electrolyte while maintaining high ionic conductivity after the pressurized heat treatment.

After heat treatment, the composite solid electrolyte may include a first solid electrolyte having a cubic garnet phase. The cubic garnet phase may be derived from an amorphous first solid electrolyte precursor. The composite solid electrolyte may further include a pyrochlore phase. Here, the pyrochlore phase may be derived from an amorphous first solid electrolyte precursor or derived from a reaction of an amorphous first solid electrolyte precursor and a glassy second solid electrolyte precursor.

The amorphous first solid electrolyte precursor may be used as a starting material for the first solid electrolyte having a cubic garnet phase. Therefore, the type and content of elements of the first solid electrolyte precursor may be substantially the same as or similar to the type and content of elements of the first solid electrolyte having a cubic garnet phase.

The first solid electrolyte precursor having an amorphous phase may include, for example, a chloride containing a cation; a nitrate containing the cation; an acetate containing the cation; a hydroxide containing the cation; a carbonate containing the cation; a sulfate containing the cation; or an oxide containing the cation, which are represented by Formula 8:

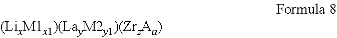

wherein, in Formula 8, M1 may be a monovalent cation, a divalent cation, a trivalent cation, or a combination thereof,
M2 may be a monovalent cation, a divalent cation, a trivalent cation, a tetravalent cation, or a combination thereof,
A may include two or more of a monovalent cation, a divalent cation, a trivalent cation, a tetravalent cation, or a pentavalent cation, and 6≤x≤8, 0≤x1≤2, 0<y≤4, 0≤y1≤4, 0<z≤3, and 0<a≤3.

The content (stoichiometric equivalent) of each of the chloride, nitrate, acetate, carbonate, hydroxide, sulfate and oxide anions in the above-described compounds may be adjusted to achieve charge neutrality of each compound.

According to an embodiment, the solid electrolyte precursor having a amorphous phase may include a compound represented by Formula 1:

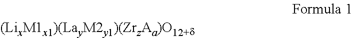

wherein in Formula 1, M1 may be a monovalent cation, a divalent cation, a trivalent cation, or a combination thereof,
M2 may be a monovalent cation, divalent cation, trivalent cation, tetravalent cation, or a combination thereof,
A may include two or more of a monovalent cation, a divalent cation, a trivalent cation, a tetravalent cation, or a pentavalent cation,
6≤x≤8, 0≤x1≤2, 0<y≤4, 0≤y1≤4, and 0<z≤3, 0<a≤3, and
δ may be a value determined to satisfy a charge neutrality condition and is in a range of −10≤1. That is, the value of δ is selected to provide the compound of Formula 1 with a neutral charge.

The definitions of M1, M2, A, x, x1, y, y1, z and a in Formula 1 may be applied in the same manner as M1, M2, A, x, x1, y, y1, z and a in Formula 1 for the above-described first solid electrolyte, and therefore, a description thereof will be omitted.

The second solid electrolyte precursor may include, for example, a compound represented by Formula 6:

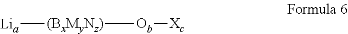

wherein, in Formula 6, a may be a number of 4 to 7, b may be a number of 12 to 13,
c may be a number of greater than 0 and equal to 1, 0<x≤7, 0≤y≤3, 0sz≤1, and 6≤x+y+z$7, M and N may be each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W, and X may be CI, Br, I, or a combination thereof.

The second solid electrolyte precursor may include, for example, a compound represented by Formula 6-1:

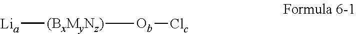

wherein, in Formula 6-1, a may be a number of 4 to 7, b may be a number of 12 to 13, c may be a number of more than 0 and 1 or less, 0<x≤7, 0≤y≤3, 0s≤≤1, and 6≤x+y+z≤7, and M and N may be each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W.

The composition for forming a composite solid electrolyte further includes a precursor containing element A of Formula 1, and the precursor containing element A may include a precursor containing, for example, sodium (Na), potassium (K), calcium (Ca), magnesium (Mg), gallium (Ga), aluminum (Al), indium (In), scandium (Sc), niobium (Nb), tantalum (Ta), antimony (Sb), tin (Sn), hafnium (Hf), tungsten (W), tellurium (Te), or a combination thereof.

The composition for forming a composite solid electrolyte may optionally contain an M1 precursor and/or an M2 precursor of Formula 1.

The M1 precursor may be a precursor including at least one of, for example, sodium (Na), potassium (K), gallium (Ga), or aluminum (Al). Further, the M2 precursor may be a precursor including at least one of, for example, calcium (Ca), strontium (Sr), cesium (Ce), or barium (Ba).

The solid electrolyte precursor having an amorphous phase according to an embodiment may be a product obtained, for example, by mechanochemical synthesis of a precursor mixture for forming a solid electrolyte precursor, for example, by high-energy mechanical milling.

The size of the solid electrolyte precursor having an amorphous phase may be a size capable of obtaining amorphous particles having a size of about 10 nm to about 1,000 μm.

The precursor having an amorphous phase may have a yield pressure of 494 megapascals (MPa) or less, or about 300 MPa to about 494 MPa. When the yield pressure of such a precursor having an amorphous phase is within the above range, this precursor has soft mechanical properties and is easy to densify. When the precursor is easy to densify, the interfacial resistance between an electrode and a solid electrolyte of a composite solid electrolyte using this precursor.

In the disclosure, the term “precursor mixture for forming a solid electrolyte precursor” refers to a mixture of precursors that are starting materials used when forming a solid electrolyte precursor.

The precursors contain a lithium precursor, a lanthanum precursor, and a zirconium precursor as essential components, and may optionally contain a M1 element-containing precursor, a M2 element-containing precursor, and an A element-containing precursor.

For example, a first solid electrolyte precursor having an amorphous phase may be prepared by mixing a mixture of a lithium precursor, a lanthanum precursor, a zirconium precursor, and an A element-containing precursor and mechanochemically synthesizing the mixture.

The lanthanum precursor, zirconium precursor and A element-containing precursor each use oxide, chloride, nitrate, acetate; hydroxide; carbonate, sulfate, or a combination thereof containing lanthanum, zirconium and an A element, respectively.

The lanthanum precursor may include, for example, La₂O₃, LaCl₃, lanthanum carbonate, lanthanum acetate, lanthanum nitrate, lanthanum hydroxide, lanthanum sulfate, or the like, and the zirconium precursor may include, for example, ZrO₂, ZrCl₂, zirconium carbonate, zirconium acetate, zirconium nitrate, zirconium hydroxide, zirconium sulfate, or the like. The tantalum precursor may include, for example, Ta₂O₅, TaCl₅, tantalum carbonate, tantalum acetate, tantalum nitrate, tantalum hydroxide, tantalum sulfate, or the like.

As the A precursor, for example, a Sc precursor, a Sn precursor, a Hf precursor, a Hf precursor, a Nb precursor, and a Sb precursor may be used. Such precursors may include oxides, chlorides, nitrates, acetates; hydroxides; carbonates; sulfates; or combinations thereof, each containing these elements.

The lithium precursor may include, for example, Li₂O, LiCI, LiOH, Li₂(CO₃), or the like. The lanthanum precursor, the zirconium precursor, the A element-containing precursor, and the lithium precursor may be used in an amount suitable for the composition of the amorphous first solid electrolyte.

The heat treatment of the mixture may be performed at about 1000° C. to about 1500° C., about 1100° C. to about 1500° C., about 1100° C. to about 1400° C., about 1200° C. to about 1400° C., or about 1200° C. to about 1350° C., and may be performed in an air or oxygen atmosphere.

According to an embodiment, the stoichiometric ratios of (lithium precursor and M1 element-containing precursor), (lanthanum precursor and M2 element-containing precursor), and (zirconium precursor and A element-containing precursor) may be controlled to about 6 to about 8, about 2 to about 4, and about 1 to about 3, respectively.

An amorphization process may be performed by a mechanochemical synthesis method. For example, the mechanochemical synthesis method may include mechanical milling and the like. The mechanical milling may include, for example, high-energy mechanical milling (HEMM). The high-energy mechanical milling is a process of complexing components by applying mechanical energy.

In the high-energy mechanical milling, powder may be atomized by applying high energy to reactants through high rotational force, and chemical reactions may be induced to reactants through maximized diffusion between powder particles. The high-energy mechanical milling is achieved using a mechanofusion device or a novirta device, and the mechanofusion is a method of forming a mixture by a strong physical rotational force in a dry state, and is a method of forming an electrostatic bonding force between constituent materials. Through this process, particulate powder having uniform distribution characteristics may be obtained.

The high-energy mechanical milling is, for example, high-energy ball milling, and the high-energy ball milling may be performed by any known ball milling device used for high-energy ball milling, such as a vibratory mill, a Z-mill, a planetary ball-mill, an attrition mill, a SPEX mill, a vibration mill, a low-temperature grinder, a friction mill, a shaker mill, a stirred ball mill, a mixer ball mill, a vertical and horizontal attritor, etc.

High-energy mechanical milling devices include, but not limited to, SPEX CertiPrep Group L.L.C. (8000 M Mixer/Mill®), Zoz GmbH (Simoloyer®), Retsch GmbH (Planetary Ball Mill PM 200/400/400 MA), and Union Process Inc. (Attritor®), commercially available. For example, Pulverisette 7 Premium line equipment may be utilized. As such, through high-energy milling, particles may be refined. Fine particles are advantageous in terms of interparticle reaction rate.

The grinding balls used in high-energy ball milling may be, but are not limited to, stainless steel beads or zirconia (ZrO₂) beads, and may have a particle size ranging from about 0.5 millimeters (mm) to about 20 mm. The grinding time of high-energy mechanical milling in the process (A) may be about 0.5 hours to about 150 hours.

High-energy mechanical milling may be performed in a dry state for about 0.5 hours to about 1000 hours, about 0.5 hours to about 100 hours, or about 10 hours to about 30 hours. High-energy mechanical milling may be performed in a dry state at a speed of, for example, about 300 revolutions per minute (rpm) to about 10000 rpm, about 350 rpm to about 5000 rpm, or about 370 rpm to about 1000 rpm. High-energy mechanical milling may be performed for about 0.5 hours to about 150 hours. In high-energy ball milling processes, temperatures may reach up to 200° C. and pressures may be on the order of 6 gigapascals (GPa) during ball milling.

By the high-energy mechanical milling, the particle size may become about 1 nm to about 100 μm, about 10 nm to about 80 μm, about 100 nm to about 50 μm, about 500 nm to about 30 μm, about 1 μm to about 10 μm, or about 1 μm to about 5 μm.

High energy mechanical milling may be performed in an inert atmosphere, which may be an atmosphere substantially free of oxygen. The inert atmosphere may be an atmosphere containing, for example, nitrogen, argon, neon, or a combination thereof. The mechanical chemical reaction may be, for example, an exothermic reaction. The reaction for forming a solid electrolyte containing a compound represented by Formula 1 may be an exothermic reaction. The temperature of the exothermic reaction may be, for example, about 100° C. to about 500° C., about 100° C. to about 400° C., about 100° C. to about 300° C., or about 100° C. to about 200° C. Mechanical milling may be carried out in a dry state, for example, without using a solvent or the like. Since mechanical milling is carried out in a dry state, post-treatment processes such as solvent removal and the like may be omitted.

During high-energy mechanical milling, if necessary, an organic solvent may be added. By performing bead mill grinding in an organic solvent, the dissolution of lithium (Li) components in the grinded material can be prevented, and a fine grinded material with a uniform composition can be obtained.

The organic solvent is at least one of an alcohol solvent, a ketone solvent, an ester solvent, a glycol ether solvent, a hydrocarbon solvent, an ether solvent, a glycol solvent, or an amine solvent. The alcohol solvent may include, for example, methanol, ethanol, butanol, hexanol, benzyl alcohol, isopropyl alcohol, or a combination thereof. The ketone solvent may include, for example, acetone, methyl ethyl ketone, methyl isobutyl ketone, cyclohexanone, or a combination thereof, and the glycol ether solvent may include, for example, methyl acetate, ethyl acetate, butyl acetate, or a combination thereof. The hydrocarbon solvent may include, for example, benzene, toluene, xylene, cyclohexane, methylcyclohexane, ethylcyclohexane, mineral oil, n-paraffin, iso-paraffin, or a combination thereof, and the ether solvent may include, for example, 1,3-dioxolane, 1,4-dioxane, tetrahydrofuran, or a combination thereof. The glycol solvent may include, for example, ethylene glycol, diethylene glycol, propylene glycol, polyethylene glycol, or a combination thereof.

The amine solvent may include, for example, monoethanolamine, diethylamine, triethanolamine, n-methyl-2-pyrrolidone, 2-amino-2-methyl-1-propanol, N, N-dimethylformamide, or a combination thereof. If a highly hydrophobic substance is used as the organic solvent, lithium (Li) is difficult to dissolve, thereby making it easy to maintain the cubic crystallinity of LLZO. In addition, when toluene is used as the organic solvent, the production of impurities can be further suppressed.

The first solid electrolyte precursor having an amorphous phase according to an embodiment may include amorphous particles having a size of about 10 nm to about 1,000 μm. The size of the first solid electrolyte precursor may be, for example, about 100 nm to about 10 μm. Here, the size refers to an average particle diameter when the first solid electrolyte precursor is spherical, and refers to an average major axis length when it is non-spherical. When the first solid electrolyte precursor having an amorphous phase contains amorphous phase particles having the above-described size, a composite solid electrolyte capable of easy densification can be prepared. When using this composite solid electrolyte, the interfacial resistance between the electrode and the composite solid electrolyte may be reduced, thereby preparing a lithium battery having improved cell performance.

The heat treatment of the above mixture is a solid-state reaction, and is performed for about 5 hours to about 50 hours, for example, about 10 hours to about 50 hours.

A composite solid electrolyte according to an embodiment may be prepared through a process of mixing a first solid electrolyte precursor having an amorphous phase and a second solid electrolyte precursor having a glass phase to prepare a composition for forming a composite solid electrolyte; and a process of heat-treating the composition for forming a composite solid electrolyte.

Before heat-treating the mixture of a composition for forming a composite solid electrolyte containing a first solid electrolyte precursor having an amorphous phase and a second solid electrolyte precursor having a glassy phase, mechanical milling may be further performed. Mechanical milling may be high-energy mechanical milling. Mechanical milling is as described above.

The heat treatment of the composition for forming a composite solid electrolyte may be performed at 600° C. or less, 550° C. or less, for example, about 350° C. to about 550° C., about 380° C. to about 550° C., about 400° C. to about 550° C., or about 450° C. to about 550° C.

### Lithium Battery

A lithium battery according to another embodiment includes a cathode, an anode, and a solid electrolyte layer between the cathode and the anode, wherein at least one of the cathode, the anode, and the solid electrolyte layer includes the composite solid electrolyte according to an embodiment.

The lithium battery may be a solid battery. Since the lithium battery includes the above-described solid electrolyte, the internal resistance of the solid battery can be reduced, and the cycle characteristics of the solid battery can be improved.

The solid battery may be, for example, an all-solid-state battery.

The solid battery uses a solid electrolyte, and for example, a cathode may contain a liquid electrolyte for a cathode.

The solid battery can be used in electronic devices, vehicles, and other applications, but can also be used for other purposes. The solid battery may be, for example, a lithium-ion battery, a lithium-air battery, or a multi-layered ceramic (MLC) battery.

When a solid battery is manufactured using the solid electrolyte according to an embodiment, very uniform interface characteristics can be secured between the solid electrolyte and the cathode. The solid battery is, for example, an all-solid-state battery. The all-solid-state battery may be, for example, an all-solid-state secondary battery. Hereinafter, solid batteries will be described in detail.

FIG. 8 is a schematic cross-sectional view of a solid secondary battery including a non-precipitated anode according to an embodiment. In a solid secondary battery including a non-precipitated anode, the initial charge capacity of an anode active material layer during an initial charging is, for example, more than 50%, 60% or more, 70% or more, 80% or more, 90% or more, or 100% or more of the initial charge capacity of a cathode active material layer.

A solid battery may be prepared as follows.

First, a solid electrolyte layer is prepared. The solid electrolyte layer includes the solid electrolyte according to an embodiment. The solid electrolyte layer may be prepared, for example, by coating and drying a composition for forming a solid electrolyte, or may be prepared by forming a composition for forming a solid electrolyte layer into powder and pressing the powder.

The composition for forming a solid electrolyte layer may contain a binder. The binder may include, but is not limited to, styrene butadiene rubber (SBR), polytetrafluoroethylene, polyvinylidene fluoride, polyethylene, and polyvinyl alcohol, and any binder used in the relevant technical field may be used. The binder of the solid electrolyte layer may be the same as or different from the binders of a cathode and an anode.

When preparing the solid electrolyte layer, the solid electrolyte layer may further include an oxide-containing solid electrolyte, a sulfide-containing solid electrolyte, or a combination thereof in addition to the solid electrolyte according to an embodiment. Next, a cathode is prepared.

The cathode may be prepared by forming a cathode active material layer including a cathode active material on a cathode current collector. The cathode active material layer may be formed by a vapor deposition method or a solid deposition method. The vapor deposition method may be, but is not limited to, pulse laser deposition (PLD), sputtering deposition, chemical vapor deposition (CVD), or the like, and any method that can be used in the relevant technical field may be used. The solid deposition method may be, but is not limited to, a sintering method, a sol-gel method, a doctor blade method, a screen printing method, a slurry casting method, a powder pressing method, or the like, and any method that can be used in the relevant technical field may be used.

As the cathode active material, a compound capable of reversible intercalation and deintercalation of lithium (lithiated intercalation compound) may be used. Specifically, at least one composite oxide of lithium and a metal selected from cobalt, manganese, nickel, and a combination thereof may be used. The composite oxide may be a lithium transition metal composite oxide, and specific examples thereof include lithium nickel-containing oxide, lithium cobalt-containing oxide, lithium manganese-containing oxide, lithium iron phosphate-containing compound, cobalt-free nickel-manganese-containing oxide, and a combination thereof. As an example, a compound represented by any one of the following formulas may be used: LiₐA_{1-b}X_{b}O_{2-c}D_{c} (0.90≤a≤1.8, 06≤b≤0.5, 0≤c≤0.05); LiₐMn_{2-b}XbO_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<<<2); LiₐNi_{1-b-c}Mn_{b}X_{c}O₂₋ₐDₐ (0.90≤a≤1.8, 0≤_{b}≤0.5, 0≤c≤0.5, 0<a<2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiaMn2G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiaFePO₄ (0.90≤a≤1.8). In the formulas, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L1 may be Mn, Al, or a combination thereof.

The cathode active material layer may additionally include a binder, a conductive material, or the like. Representative examples of the binder may include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and nylon. Examples of the conductive material may include carbon-containing materials such as natural graphite, artificial graphite, carbon black, acetylene black, Ketjen black, carbon fibers, carbon nanofibers, and carbon nanotubes; metal-containing materials containing copper, nickel, aluminum, and silver in the form of metal powder or metal fibers; conductive polymers such as polyphenylene derivatives; and a combination thereof.

As the cathode current collector, Al may be used, but the disclosure is not limited thereto.

The cathode may contain the solid electrolyte according to an embodiment.

Next, an anode is prepared. The anode is prepared in the same manner as the cathode, except that an anode active material is used instead of a cathode active material. The anode may be prepared by forming an anode active material layer containing an anode active material on a current collector.

The anode active material may include a material capable of reversibly intercalating/deintercalating lithium ions, lithium metal, a lithium metal alloy, a material capable of doping and dedoping lithium, or a transition metal oxide.

The material capable of reversibly intercalating/deintercalating lithium ions may be a carbon-containing anode active material, for example, crystalline carbon, amorphous carbon, or a combination thereof. Examples of the crystalline carbon may include graphite such as natural graphite or artificial graphite having an amorphous, plate-like, flake-like, spherical or fibrous form, and examples of the amorphous carbon may include soft carbon or hard carbon, mesophase pitch carbide, calcined and coke.

As the lithium metal alloy, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-containing anode active material or a Sn-containing anode active material may be used. The Si-containing anode active material may be silicon, a silicon-carbon composite, SiOx (0<x<2), a Si—Q alloy (wherein Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-containing anode active material may be Sn, SnO₂, a Sn-containing alloy, or a combination thereof.

The anode active material layer may additionally include a binder, a conductive material, or the like. The binder and the conductive material may be selected from the materials used in the above-described cathode active material layer.

Referring to FIG. 8, a solid battery 40 includes a solid electrolyte layer 30, a cathode 10 disposed on one side of the solid electrolyte layer 30, and an anode 20 disposed on the other side of the solid electrolyte layer 30. The cathode 10 includes a cathode active material layer 12 in contact with the solid electrolyte layer 30 and a cathode current collector 11 in contact with the cathode active material layer 12, and the anode 20 includes an anode active material layer 22 in contact with the solid electrolyte layer 30 and an anode current collector 21 in contact with the anode active material layer 22. In the solid battery 40, for example, a solid secondary battery 40 is completed by forming a cathode active material layer 12 and an anode active material layer 22 on both sides of the solid electrolyte layer 30 and forming a cathode current collector 11 and an anode current collector 21 on the cathode active material layer 12 and the anode active material layer 22, respectively. Alternatively, a solid battery 40 is completed by sequentially stacking an anode active material layer 22, a solid electrolyte layer 30, a cathode active material layer 12, and a cathode current collector 11 on an anode current collector 21.

Type 2: Solid battery using deposited anode

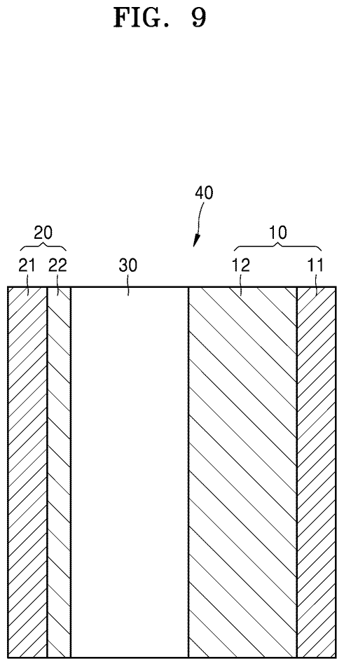

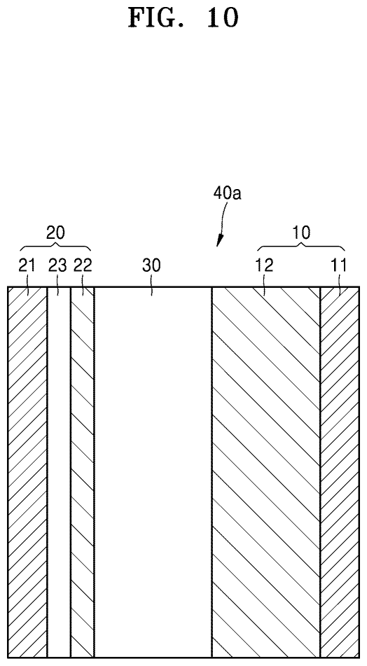

FIGS. 9 and 10 are schematic cross-sectional views of a solid battery including a deposited anode according to an embodiment. A solid battery may be, for example, a solid secondary battery.

A solid battery 40 includes a cathode 10 including a cathode active material layer 12 disposed on a cathode current collector 11; an anode 20 including an anode active material layer 22 disposed on an anode current collector 21; and an electrolyte layer 30 disposed between the cathode 10 and the anode 20. The cathode active material layer 12 and/or the solid electrolyte layer 30 may include the composite solid electrolyte according to an embodiment.

Referring to FIGS. 9 and 10, the anode 20 includes an anode current collector 21 and an anode active material layer 22 disposed on the anode current collector 21, and the anode active material layer 22 includes, for example, an anode active material and a binder.

The anode active material included in the anode active material layer 22 has, for example, a particle form. The average particle size of the anode active material having a particle form is, for example, 4 μm or less, about 10 nm to about 4 μm, about 10 nm to about 3 μm, about 10 nm to about 2 μm, about 10 nm to about 1 μm, or about 10 nm to about 900 nm. Since the anode active material has an average particle size in this range, reversible absorption and/or desorption of lithium can be facilitated during charge and discharge. The average particle size of the anode active material is, for example, a median diameter (D50) measured using a laser particle size distribution meter.

The anode active material included in the anode active material layer 22 includes, for example, at least one selected from a carbon-containing anode active material and a metal or metalloid anode active material.

The carbon-containing anode active material uses, for example, amorphous carbon. Example of the amorphous carbon include, but are not limited to, carbon black, acetylene black, furnace black (FB), ketjen black (KB), and graphene, and any material classified as amorphous carbon in the relevant technical field is possible.

The metal or metalloid anode active material may include at least one of gold (Au), platinum (Pt), palladium (Pd), silicon (Si), silver (Ag), aluminum (Al), bismuth (Bi), tin (Sn), or zinc (Zn). The anode active material included in the anode active material layer 22 includes, for example, a mixture of first particles made of amorphous carbon and second particles made of a metal or metalloid. The content of the second particles is about 8 wt % to about 60 wt %, about 10 wt % to about 50 wt %, about 15 wt % to about 40 wt %, or about 20 wt % to about 30 wt % based on the total weight of the mixture. When the second particle has a content in this range, the cycle characteristics of the solid secondary battery 40 are further improved.

The binder included in the anode active material layer 22 may be, but is not necessarily limited to, styrene-butadiene rubber (SBR), polytetrafluoroethylene, polyvinylidene fluoride, polyvinylidene fluoride-hexafluoropropylene copolymer, polyethylene oxide polyacrylonitrile, polymethyl methacrylate, carboxymethyl cellulose, hydroxypropyl methyl cellulose, methyl cellulose, or an alkali metal salt thereof, and any binder used in the relevant technical field may be used. The anode active material layer 22 includes a binder, so that the anode active material layer 22 is stabilized on the anode current collector 21. In addition, cracks in the anode active material layer 22 are suppressed despite changes in the volume and/or relative position of the anode active material layer 22 during a charge/discharge process.

Referring to FIG. 9, a solid battery 40a may further include, for example, a metal layer 23 disposed between the anode current collector 21 and the anode active material layer 22. The metal layer 23 may be a metal foil or a plated metal layer. The metal layer 23 includes lithium or a lithium alloy. Therefore, the metal layer 23 acts as a lithium reservoir, for example. The lithium alloy includes, for example, a Li—Al alloy, a Li—Sn alloy, a Li—In alloy, a Li—Ag alloy, a Li—Au alloy, a Li—Zn alloy, a Li—Ge alloy, and a Li—Si alloy. The thickness of the metal layer 23 is, for example, about 1 μm to about 200 μm, about 1 μm to about 100 μm, about 1 μm to about 70 μm, about 1 μm to about 50 μm, about 1 μm to about 30 μm, or about 1 μm to about 20 μm. When the thickness of the metal layer 23 is within the above range, the cycle characteristics of the solid battery 40 can be improved.

In the solid battery 40a, the metal layer 23 is, for example, disposed between the anode collector 21 and the anode active material layer 22 before assembling the solid battery 40a, or is deposited between the anode current collector 21 and the anode active material layer 22 by charging after assembling the solid battery 40a. When the metal layer 23 is disposed between the anode current collector 21 and the anode active material layer 22 before assembling the solid secondary battery 40a, the metal layer 23 is a metal layer containing lithium and thus functions as a lithium reservoir. When the metal layer 23 is deposited by charging after assembling the solid secondary battery 40a, the energy density of the solid secondary battery 40a increases because the metal layer 23 is not included when assembling the solid secondary battery 40a. In addition, when the metal layer 23 is deposited by charging after assembling the solid secondary battery 40a, the anode current collector 21, the anode active material layer 22 and the region therebetween are Li-free regions that do not include lithium (Li) in the initial state or post-discharge state of the solid battery 40a.

The anode current collector 21 is composed of, for example, a material that does not react with lithium, i.e., does not form an alloy or compound. The materials constituting the anode current collector 21 include, but are not necessarily limited to, copper (Cu), stainless steel, titanium (Ti), iron (Fe), cobalt (Co), and nickel (Ni), and any material that can be used as an electrode current collector in the relevant technical field may be used. The anode current collector 21 may be composed of one of the above-described metals, or may be composed of an alloy or coating material of two or more metals.

The solid battery may further include a thin film containing an element capable of forming an alloy with lithium on the anode current collector 21. The thin film is disposed between the anode current collector 21 and the anode active material layer 22. The thin film includes an element capable of forming an alloy with lithium, for example, includes gold (Au), silver (Ag), zinc (Zn), tin (Sn), indium (In), silicon (Si), aluminum (Al), bismuth (Bi), or the like. The thin film may be composed of one of these metals, or composed of an alloy of several types of metals. Since the thin film is disposed on the anode current collector 21, for example, the deposition shape of the metal layer 23 deposited between the thin film and the anode active material layer 22 becomes flatter, and the cycle characteristics of the solid battery 40 or 40a can be further improved.

The thickness of the thin film is, for example, about 1 nm to about 800 nm, about 10 nm to about 700 nm, about 50 nm to about 600 nm, or about 100 nm to about 500 nm. When the thickness of the thin film is within the above range, a solid secondary battery having improved cycle characteristics can be manufactured. The thin film may be disposed on the anode current collector 21 by a vacuum deposition method, a sputtering method, a plating method, or the like.

### Muti-Layered Ceramic Battery

Multi-layered ceramic batteries are small or ultra-small batteries that can be applied as power sources for applications such as the Internet of Things (IoT) and wearable devices. Multi-layered ceramic batteries can also be applied to medium and large-sized batteries, such as electric vehicles (EVs) and energy storage systems (ESS).

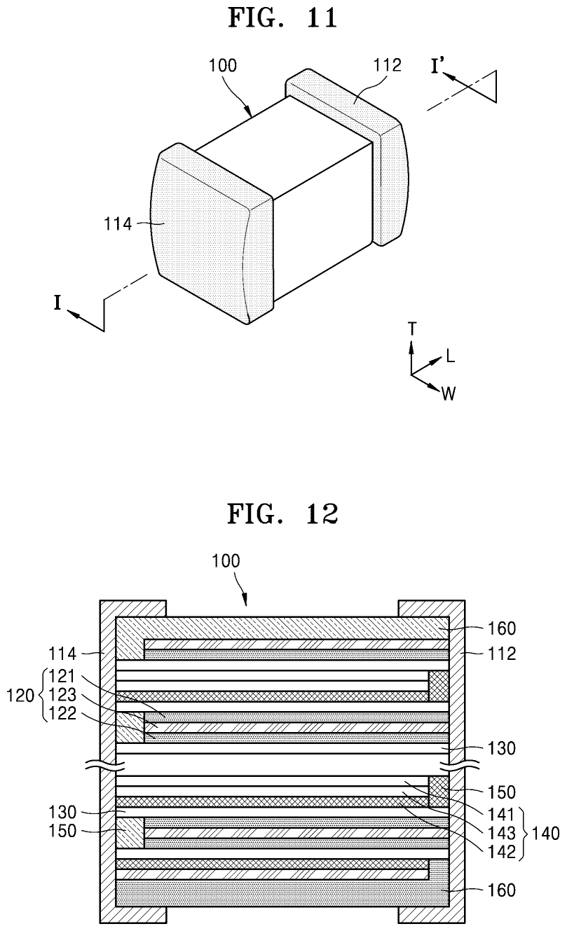

FIG. 11 is a perspective view schematically illustrating a multi-layered ceramic battery according to an embodiment. FIG. 12 is a cross-sectional view of a multi-layered ceramic battery according to an embodiment. Referring to FIGS. 11 and 12, two sides facing each other in the thickness direction (T-axis direction) of a solid battery 100 are defined as a first side and a second side, and two sides connected to the first side and the second side and facing each other in the length direction (L direction) of the solid battery 100 are defined as a third side and a fourth side. For example, the first side and second side facing each other of the solid battery 100 may correspond to the third side and fourth side.

The multi-layered ceramic battery 100 includes a cathode 120 and an anode 140, and includes a solid electrolyte layer 130 disposed between the cathode 120 and the anode 140 in a stacking direction.

The solid electrolyte layer 130 may contain a solid electrolyte according to an embodiment.

The solid electrolyte layer 130 may be disposed in a stacking direction between cathode active material layers 121 and 122 of the cathode 120 and anode active material layers 141 and 142 of the anode 140. In the solid battery 100, the plurality of cathodes 120 and the plurality of anodes 140 may be alternately arranged in a stacking direction, and the plurality of solid electrolyte layers 130 may be arranged between the cathodes 120 and anodes 140 that are alternately arranged in a stacking direction. The solid battery 100 may be manufactured by alternately arranging the plurality of cathodes 120 and the plurality of anodes 140 in a stacking direction, arranging the plurality of solid electrolyte layers 130 between each of the alternately arranged cathodes 120 and each of the alternately arranged anodes 140 to prepare an electrode-electrolyte laminate, and then sintering the electrode-electrolyte laminate at once.

The cathode 120 includes a cathode current collector 123 and cathode active material layers 121 and 122 disposed on one side or both sides of the cathode current collector 123. The anode 140 includes an anode current collector 143 and anode active material layers 141 and 142 disposed on one side or both sides of the anode current collector 143.

The cathode active material layers 121 and 122 may include a cathode active material. The cathode active material may be selected from the cathode active material materials used in the solid battery. The cathode active material includes at least one of lithium metal phosphorus oxides, and lithium metal oxides, for example, lithium cobalt oxides, lithium iron phosphorus oxides, lithium nickel cobalt manganese oxides, lithium nickel cobalt aluminum oxides, lithium nickel cobalt aluminum oxides or combinations thereof.

The cathode active material layer may further include a conductive material, a binder, or a combination thereof.

The binder and the conductive material may be those mentioned in the binder and conductive material of the solid battery.

The cathode current collector 123 may include, for example, a metal-containing substrate or a carbon-containing substrate. As the metal-containing substrate, for example, a porous body, mesh, plate or foil made of stainless steel, nickel (Ni), aluminum (Al), indium (In), copper (Cu), magnesium (Mg), titanium (Ti), iron (Fe), cobalt (Co), nickel (Ni), zinc (Zn), germanium (Ge), lithium (Li), or an alloy thereof may be used. The cathode current collector 123 may be, for example, a sintered product of metal powder used in the above-described metal-containing substrate. The carbon-containing substrate may include, for example, a one-dimensional carbon-containing material such as a carbon fiber or a carbon tube; a two-dimensional carbon-containing material such as graphite or graphene; or a combination thereof. The cathode current collector 123 may further include a binder. The binder may be selected from the binders used in the cathode active material layers 121 and 122. The cathode current collector 123 may be omitted.

The anode active material layers 141 and 142 include an anode active material.

The anode active material includes, for example, at least one of lithium metal phosphate, lithium metal oxide, metal oxide, or a carbon-containing anode active material.

The carbon-containing anode active material includes, for example, amorphous carbon, crystalline carbon, porous carbon, or a combination thereof. Examples of crystalline carbon may include graphite, such as natural graphite or artificial graphite, which may be non-shaped, plate-like, flake-like, spherical, or fibrous.

Amorphous carbon may include, for example, carbon black (CB), acetylene black (AB), furnace black (FB), ketjen black (KB), graphene, soft carbon or hard carbon, mesophase pitch carbide, and calcined coke. Amorphous carbon is distinguished from crystalline carbon as carbon that has no crystallinity or very low crystallinity.

The carbon-containing anode active material may be, for example, porous carbon. The volume of pores included in the porous carbon is, for example, about 0.1 cubic centimeter per gram (cc/g) to about 10.0 cc/g, about 0.5 cc/g to about 5 cc/g, or about 0.1 cc/g to about 1 cc/g. The average diameter of pores included in the porous carbon is, for example, about 1 nm to about 50 nm, about 1 nm to about 30 nm, or about 1 nm to about 10 nm. The BET specific surface area of porous carbon is, for example, about 100 square meters per gram (m²/g) to about 3000 m²/g.

The anode active material is a compound selected from the group consisting of, for example, Li_{4/3} Ti_{5/3}O₄, LiTiO₂, LiM1ₛM2ₜOᵤ (M1 and M2 are transition metals, and s, t, u are any positive numbers), TiOₓ (0<x≤3), and LiₓV₂ (PO₄)3(0<x≤5). The anode active material according to an embodiment may include Li_{4/3}Ti_{5/3}O₄, LiTiO₂, or a combination thereof.

The anode active material layers 141 and 142 may further include a conductive material, a binder, or a combination thereof. The conductive material and the binder may be selected from the conductive materials and binders used in the cathode active material layers 121 and 122, respectively. The contents of the conductive material and binder used in the anode active material layers 141 and 142 may be selected from the contents of the conductive material and binder used in the cathode active material layers 121 and 122, respectively. The binder may be partially or completely removed by vaporization and/or carbonization during the sintering process of the anode active material layers 141 and 142. The binder may be omitted.

The anode current collector 143 may be selected from the metal-containing substrate or carbon-containing substrate used in the anode current collector 123.

The solid electrolyte layer 130 may include the solid electrolyte according to an embodiment. The solid electrolyte layer 130 may further include another oxide-containing solid electrolyte.

The oxide-containing solid electrolyte may include, for example, a Garnet-type solid electrolyte, a Nasicon-type solid electrolyte, a LISICON-type solid electrolyte, a perovskite-type solid electrolyte, a LiPON-type solid electrolyte, an amorphous (glassy) solid electrolyte, or a metal oxide.

The solid electrolyte layer 130 may further include a binder. The binder may be selected from the binders used in the cathode active material layers 121 and 122. The content of the binder used in the solid electrolyte layer 130 may be selected from the contents of the binders use

d in the cathode active material layers 121 and 122. The binder may be partially or completely removed by vaporization and/or carbonization during the sintering process of the solid electrolyte layer 130. The binder may be omitted.

The solid electrolyte layer 130 may be disposed in a stacking direction between the cathode active material layers 121 and 122 of the cathode 120 and the anode active material layers 141 and 142 of the anode 140. In the multi-layered ceramic battery 100, the plurality of cathodes 120 and the plurality of anodes 140 may be arranged alternately in the stacking direction, and the plurality of solid electrolyte layers 130 may be arranged between the cathodes 120 and anodes 140 that are arranged alternately in the stacking direction. The multi-layered ceramic battery may be manufactured by alternately arranging the plurality of cathodes 120 and the plurality of anodes 140 in the stacking direction, arranging the plurality of solid electrolyte layers 130 between each of the alternately arranged cathodes 120 and each of the alternately arranged anodes 140 to prepare an electrode-electrolyte laminate, and then sintering the electrode-electrolyte laminate.

The multi-layered ceramic battery may be manufactured by alternately arranging the plurality of cathodes 120 and the plurality of anodes 140 in the stacking direction, arranging a solid electrolyte precursor layer having an amorphous phase between each of the alternately arranged cathodes 120 and each of the alternately arranged anodes 140 to prepare an electrode-electrolyte precursor laminate, and then sintering the electrode-electrolyte precursor laminate. In the sintering process, the electrolyte precursor may be crystallized into a cubic crystal phase to become a solid electrolyte.

A solid electrolyte precursor layer having an amorphous phase is disposed on a substrate. When the solid electrolyte precursor layer is in a free-standing state, the substrate may be omitted.

A cathode active material layer may be formed on the solid electrolyte precursor layer. Subsequently, a cathode current collector may be formed on the other side of the cathode active material layer provided with the solid electrolyte precursor layer on one side thereof to form a laminate of solid electrolyte precursor layer/cathode active material/cathode current collector.

Separately, an anode active material layer may be formed on the substrate and the solid electrolyte precursor layer disposed on the substrate. Subsequently, an anode current collector may be formed on the other side of the anode active material layer provided with the solid electrolyte precursor layer on one side thereof to form a laminate of solid electrolyte precursor layer/anode active material/anode current collector.

The cathode current collector and the anode current collector each contain a metal selected from copper, aluminum, nickel, silver, gold, and an alloy thereof, a conductive oxide, or a combination thereof. As a specific example, aluminum may be used as the cathode current collector, and copper may be used as the anode current collector. The anode current collector may be omitted.

The substrate is separated and removed from the two laminates. The two laminates from which the substrate has been removed are laminated to form a battery structure. The battery structure may include a structure of a cathode current collector/cathode active material layer/solid electrolyte precursor layer/anode active material/anode current collector.

A unit cell including a cathode current collector/cathode active material layer/solid electrolyte layer/anode active material/anode current collector may be manufactured by sintering the structure.

The sintering may be performed at a temperature of 700° C. or lower. For example, sintering temperature may be 400° C. or higher and 700° C. or lower, 450° C. or higher and 600° C. or lower, or 50° C. or higher and 600° C. or lower. During this sintering, the amorphous solid electrolyte precursor is crystallized to be converted into a solid electrolyte.

The battery structure is further pressed. The pressing may be performed before or simultaneously with the sintering process. The pressing may be performed in a range of about 50 MPa to about 500 MPa.

A margin layer 150 may be disposed along the side surfaces of the cathode 120 and the anode 130 to at least partially surround the cathode 120 and the anode 130. The margin layer 150 may be disposed on the solid electrolyte layer 130, and may be disposed along a side surface adjacent to the side surfaces of the cathode active material layers 121 and 122 and/or the anode active material layers 141 and 142 to at least partially surround the cathode active material layers 121 and 122 and/or the anode active material layers 141 and 142. The margin layer 150 may be disposed in the same layer as the cathode active material layers 121 and 122 and/or the anode active material layers 141 and 142.

The margin layer 150 may include, for example, an insulating material or a conductive material. The margin layer 150 may include, for example, an insulator having an ionic conductivity of 1/100 or less or 1/1000 or less than that of the solid electrolyte layer 130. The margin layer 150 may include, for example, an insulating polymer. Examples of the Insulating polymer may include, but are not limited to, polyolefins such as polyethylene and polypropylene; polyesters such as polyethylene terephthalate (PET); polyurethanes; and polyimides.

The anode 120, the solid electrolyte layer 130, the cathode 140, and the margin layer 150 may be laminated as described above to form an electrode-electrolyte laminate. Protective layers 160 may be disposed on the upper and lower ends of the electrode-electrolyte laminate. The protective layer may include, for example, an insulating material.

A terminal of the cathode current collector 123 and a terminal of the anode current collector 143 are exposed to both side surfaces of the electrode-electrolyte laminate of the multi-layered ceramic battery 100. The exposed terminals are connected and bonded to external electrodes 112 and 114. The external electrode 112 connected to the exposed terminal of the cathode current collector 123 may act as a cathode. The external electrode 114 connected to the exposed terminal of the anode current collector 143 may act as an anode.

The external electrodes 112 and 114 may include a conductive metal and a glass component.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

The glass component included in the external electrodes 112 and 114 may be a composition in which oxides are mixed. The glass component may include, for example, silicon oxide, boron oxide, aluminum oxide, a transition metal oxide, an alkali metal oxide, an alkaline earth metal oxide, or a combination thereof. The transition metal included in the glass component may be at least one of zinc (Zn), titanium (Ti), copper (Cu), vanadium (V), manganese (Mn), iron (Fe), or nickel (Ni), the alkali metal may be at least one of lithium (Li), sodium (Na), or potassium (K), and the alkaline earth metal may be at least one of magnesium (Mg), calcium (Ca), strontium (Sr), or barium (Ba).

The external electrodes 112 and 114 may be formed, for example, by dipping a cell laminate into conductive paste containing a conductive metal and glass. The external electrodes 112 and 114 may be formed, for example, by printing conductive paste on the surface of a cell laminate using a screen printing method or a gravure printing method. The external electrodes 112 and 114 may be formed, for example, by applying conductive paste to the surface of a cell laminate or by transferring a dry film of conductive paste onto the cell laminate.

A method of manufacturing a multi-layered ceramic battery according to an embodiment will be described in detail as follows.

First, a first solid electrolyte precursor having a cubic garnet phase is mixed with a second solid electrolyte having a glass phase to obtain a composition for forming a composite electrolyte, and the composition is applied onto a substrate and dried to form a composite electrolyte precursor film. The composite solid electrolyte precursor film contains i) a first solid electrolyte precursor having an amorphous phase and ii) a second solid electrolyte precursor having a glass phase.

When the composite solid electrolyte precursor film has a free-standing state, the substrate may be omitted.

A cathode is formed by printing a composition for forming a cathode on the substrate and the composite solid electrolyte precursor film disposed on the substrate

The composition for forming a cathode may contain a cathode active material and a binder. Here, the cathode active material and the binder may be the same as those used in the solid secondary battery. In addition, the composition for forming a cathode may contain i) a first solid electrolyte precursor having an amorphous phase and ii) a second solid electrolyte precursor having a glass phase, which are contained in the composition for forming a composite solid electrolyte according to an embodiment.

Subsequently, a cathode current collector and a cathode are formed on the other side of the cathode provided with the composite solid electrolyte precursor film on the surface thereof to form a laminate of a substrate/composite solid electrolyte precursor film/cathode/cathode current collector/cathode. The cathode current collector may be formed, for example, by printing a composition for forming a cathode current collector.

Separately, a composition for forming an anode is printed on the substrate and the composite solid electrolyte precursor film disposed on the substrate to form an anode.

The composition for forming an anode may contain an anode active material and a binder. Here, the binder may be applied in the same manner as that used in the solid secondary battery.

The composition for forming a cathode and the composition for forming an anode may include a solvent.

Subsequently, an anode current collector and an anode are formed on the other side of the anode provided with the composite solid electrolyte precursor film on the surface thereof to form a laminate of a substrate/composite solid electrolyte precursor film/anode/anode current collector/anode. The anode current collector may be formed, for example, by printing a composition for forming an anode current collector.

The substrate is separated and removed from the laminate of a substrate/composite solid electrolyte precursor film/cathode/cathode current collector/cathode. The composite solid electrolyte precursor film formed by removing the substrate in this way, and the composite solid electrolyte precursor film formed by removing the substrate from the laminate of substrate/composite solid electrolyte precursor film/anode/anode current collector/cathode are laminated and pressed to form a battery structure.

The composition for forming a cathode current collector and the composition for forming an anode current collector each contain a metal selected from copper, aluminum, nickel, silver, gold, and an alloy thereof, a conductive oxide, or a combination thereof. As a specific example, aluminum may be used as the cathode current collector, and copper may be used as the anode current collector.

Subsequently, cutting is performed on the pressed battery structure. Here, the cutting size of the battery structure depends on the capacity of the multi-layered ceramic battery, for example, width about 5 mm to about 15 mm, for example 10 mm, length about 5 mm to about 15 mm, for example 10 mm. This cutting process may be omitted.

A unit cell in which a cathode/current collector/cathode/composite solid electrolyte/anode/current collector/anode are laminated may be manufactured by performing cosintering on the structure obtained through the above process,

The cosintering is performed, for example, at a temperature of 550° C. or lower. During this sintering process, a composite solid electrolyte film containing a first solid electrolyte precursor having an amorphous phase and a second solid electrolyte precursor having a glass phase is converted into a composite solid electrolyte containing a first solid electrolyte having a cubic garnet phase and a pyrochlore phase and a second solid electrolyte including lithium haloborasite having a crystalline phase.

The plurality of unit cells obtained through the above process may be laminated to form an external electrode, thereby manufacturing a multi-layered ceramic battery according to an embodiment.

Hereinafter, the disclosure will be described in more detail with reference to the following examples and comparative examples, but the scope of the disclosure is not limited to these examples.

### Preparation Example 1: Preparation of Amorphous Solid Electrolyte Precursor

Precursors Li₂O, La₂O₃, ZrO₂, HfO₂, SnO₂, Sc₂O₃, and Ta₂O₅ were mixed in a molar ratio of 6.5:3:0.4:0.4:0.4:0.15:0.65 and put into a high-energy ball mill, and dry milled at 370 rpm for 15 hours in an inert atmosphere to obtain an amorphous solid electrolyte precursor (Li_{6.5}La₃Zr_{0.4}Hf_{0.4}Sn_{0.4}SC_{0.15}Ta_{0.65}O₁₂) (a-LLMO) in a powder state with an average particle size (D50) of about 2 μm.

### Preparation Example 2: Preparation of Li₄B₄Al₃O₁₂Cl having glass phase

Li₂CO₃, B₂O₃, γ-Al₂O₃, and LiCl were mixed in a molar ratio of 2.8:4:3:3.2, and the mixture was heat-treated at 1100° C. in an electric furnace to obtain a liquid product. The liquid product was quenched to obtain Li₄B₄Al₃O₁₂Cl having a glass phase.

### Comparative Preparation Example 1: Crystalline Solid Electrolyte

To obtain crystalline Li_{6.5}La₃Zr_{1.5}Ta_{0.5}O₁₂, precursors Li₂O, La₂O₃, ZrO₂, and Ta₂O₅ were mixed stoichiometrically and heat-treated at 900° C. or higher to obtain crystalline Li_{6.5}La₃Zr_{1.5}Ta_{0.5}O₁₂ in a powder state with an average particle size (D50) of about 2 μm. This powder is a solid electrolyte powder (c-LLZTO) having a garnet crystal structure (cubic phase).

### Reference Preparation Example 1: Preparation of Amorphous Solid Electrolyte Precursor

To obtain amorphous Li_{6.5}La₃Zr_{1.5}Ta_{0.5}O₁₂, precursors Li₂O, La₂O₃, ZrO₂ and Ta₂O₅ were mixed stoichiometrically and put into a high-energy ball mill, and dry milled at 375 rpm for 15 hours in an inert atmosphere to prepare amorphous solid electrolyte powder (Li_{6.5}La₃Zr_{1.5}Ta_{0.5}O₁₂). This product was obtained in a powder state with an average particle size (D50) of about 2 μm.

### Preparation of Composite Solid Electrolyte

### Example 1: Preparation of Composite Solid Electrolyte

The first solid electrolyte precursor (Li_{6.5}La₃Zr_{0.4}Hf_{0.4}Sn_{0.4}SC_{0.15} Ta_{0.65}O₁₂) (a-LLMO) having an amorphous phase obtained according to Preparation Example 1, and the glass powder Li₄B₄Al₃O₁₂CI (LCBA) having a glass phase obtained according to Preparation Example 2 were mixed to prepare a mixture. a-LLMO is an abbreviation of amorphous-LLMO.

The mixture was sintered by hot press sintering (HPS) at 500° C. for 2 hours under 250 MPa in an air atmosphere to prepare a composite solid electrolyte sintered body having a thickness of about 500 μm. The mixing volume ratio of the first solid electrolyte precursor having an amorphous phase and the glass powder was 95:5.

The composite solid electrolyte obtained according to Example 1 contains a first solid electrolyte having a cubic garnet phase, and lithium chloroboracite as a second solid electrolyte.

### Example 2: Preparation of Composite Solid Electrolyte

A composite solid electrolyte was prepared in the same manner as in Example 1, except that the mixing volume ratio of the first solid electrolyte precursor having an amorphous phase obtained according to Preparation Example 1 and the glass powder was 90:10.

### Example 3: Preparation of Composite Solid Electrolyte

A composite solid electrolyte was prepared in the same manner as in Example 1, except that the mixing volume ratio of the first solid electrolyte precursor having an amorphous phase obtained according to Preparation Example 1 and the glass powder was 80:20.

### Example 4: Preparation of Composite Solid Electrolyte

The first solid electrolyte precursor (Li_{6.5}La₃Zr_{0.4}Hf_{0.4}Sn_{0.4}SC_{0.15} Ta_{0.65}O₁₂) (a-LLMO) having an amorphous phase obtained according to Preparation Example 1, and the glass powder Li₄B₄Al₃O₁₂CI (LCBA) having a glass phase obtained according to Preparation Example 2 were mixed to obtain a mixture. The mixture was sintered by hot press sintering (HPS) at 600° C. for 2 hours under 250 MPa in an air atmosphere to prepare a composite solid electrolyte sintered body having a thickness of about 500 μm. The mixing volume ratio of the first solid electrolyte precursor having an amorphous phase and the glass powder was 95:5.

The composite solid electrolyte obtained according to Example 4 contains a first solid electrolyte having a cubic garnet phase, and lithium chloroboracite as a second solid electrolyte.

### Comparative Example 1: Preparation of Solid Electrolyte

Commercially available Li_{6.5}La₃Zr_{1.5}Ta_{0.5}O₁₂ powder (LLZ powder, Toshima Ltd., hereinafter referred to as C-LLZTO) having a garnet crystal structure (cubic phase) was sintered by HPS at 480° C. for 2 hours under 250 MPa in an air atmosphere to prepare a sintered body having a thickness of about 500 μm. This sintered body was used as a solid electrolyte (c-LLZTO).

### Comparative Example 2: Preparation of Composite Solid Electrolyte

A composite solid electrolyte was prepared in the same manner as in Example 1, except that C-LLZTO of Comparative Example 1 was used instead of the first solid electrolyte precursor having an amorphous phase obtained according to Preparation Example 1, and that the mixing volume ratio of C-LLZTO of Comparative Example 1 and glass powder was 95:5. The same glass powder as in Example 1 was used as the glass powder.

### Comparative Example 3: Preparation of Composite Solid Electrolyte

A composite solid electrolyte was prepared in the same manner as in Comparative Example 2, except that the mixing volume ratio of C-LLZTO of Comparative Example 1 and glass powder was 90:10.

### Reference Example 1: Preparation of Solid Electrolyte (Heat Treatment at 500° C.) (LCBA 0%)

The amorphous solid electrolyte precursor (a-LLMO) obtained according to Preparation Example 1 was pulverized to obtain an amorphous solid electrolyte precursor powder.

The amorphous solid electrolyte precursor powder was pressed and heat-treated at a temperature of 500° C. and a pressure of 0.25 GPA for 2 hours in an argon atmosphere, and was pelletized to obtain a pellet-shaped solid electrolyte (d-LLMO). d-LLMO may be a somewhat disordered crystalline state of a-LLMO (amorphous-LLMO) after heat treatment.

### Reference Example 2: Preparation of Solid Electrolyte (Heat Treatment at 600° C.)

The amorphous solid electrolyte precursor obtained according to Preparation Example 1 was pulverized to obtain an amorphous solid electrolyte precursor powder.

The amorphous solid electrolyte precursor powder was pressed and heat-treated at a temperature of 600° C. and a pressure of 0.25 GPA for 2 hours, and was pelletized to obtain a pellet-shaped solid electrolyte.

### Evaluation Example 1: Differential Scanning Calorimetry (DSC) Analysis

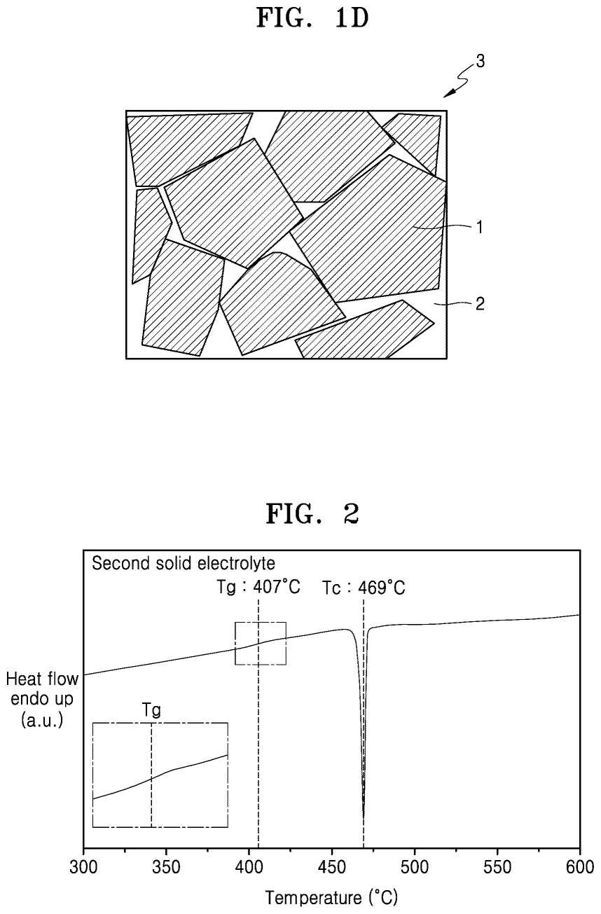

DSC analysis was performed on the first solid electrolyte precursor having an amorphous phase and the second solid electrolyte precursor having a glass phase used in the preparation of the composite solid electrolyte of Example 1, and the results thereof are shown in FIG. 2.

Referring to FIG. 2, it was found that the first solid electrolyte precursor exhibits an exothermic peak at a lower temperature than the second solid electrolyte precursor, thereby indicating that the first solid electrolyte has a lower crystallization temperature than the second solid electrolyte. Further, as shown in FIG. 2B, it was found that the glass transition temperature of the second solid electrolyte is in the region near the crystallization temperature Tc of the first solid electrolyte. The second solid electrolyte having fluidity could be filled into the pores formed when the first solid electrolyte was crystallized.

### Evaluation Example 2: X-Ray Diffraction Analysis

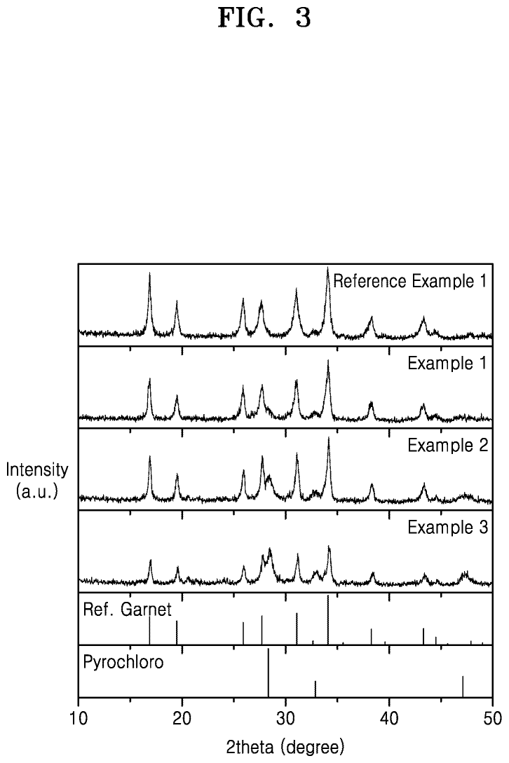

XRD spectra on the composite solid electrolytes of Examples 1 to 3, the solid electrolyte of Reference Example 1, Ref. Garnet (LLZTO), and Ref. Pyrochlore were measured, and the results thereof are shown in FIG. 3. XRD spectra were measured using X′pert pro (PANalytical) with Cu Kα radiation (1.54056 Å). In FIG. 3, Ref. Garnet refers to a cubic garnet phase (LLZTO) (Li_{6.5}La_{2.4}Zr_{1.2}Ta_{0.4}O₁₂), and Pyrochlore refers to LZT (La_{2.4}Zr_{1.2}Ta_{0.4}O₇).

As shown in FIG. 3, it was confirmed that the composite solid electrolytes of Examples 1 to 3 include a garnet phase and contain a pyrochlore phase crystal material.

The composite solid electrolytes of Examples 1 to 3 contained a cubic garnet crystal phase as a main phase and a small amount of pyrochlore phase, and peaks related to the pyrochlore phase appear at diffraction angles 2θ of 28.35° (crystal plane (111)), 32.85°, and 47.14° (crystal plane (220)).

It can be found that as the content of the second solid electrolyte increases, the content of the pyrochlore phase crystal material increases compared to the garnet phase crystal material. In this case, the peak (first peak) in the region with a diffraction angle of 34° is related to the garnet phase, and the peak (second peak) in the region with a diffraction angle 2θ of 28.35° is related to the pyrochloro phase. The mixing ratio of garnet-phase crystal material and pyrochlore-phase crystal material can be determined through their peak intensity ratio (la/lb).

Referring to the intensity ratio (la/lb) of the first peak to the second peak of FIG. 3, it can be found that as the content of the second solid electrolyte in the composite solid electrolytes of Examples 1 to 3 increases, the content of the pyrochlore phase crystal material increases.

### Evaluation Example 3: Ionic Conductivity Measurement

A shielding electrode was deposited on both sides of the composite solid electrolytes of Examples 1 to 3, the solid electrolyte of Comparative Example 1 and the composite solid electrolyte pellets prepared in Comparative Examples 2 to 3 by sputtering a gold (Au) electrode. Impedances for specimens with shielding electrodes formed on both sides were measured by a two-probe method using an impedance analyzer (Solartron 1400A/1455A impedance analyzer). A frequency range was 1 hertz (Hz) to 1 megahertz (MHZ), and an amplitude voltage was 10 millivolts (mV). The impedances were measured at 25° C. in a dry air atmosphere. Resistance values were obtained from the arc of the Nyquist plot for the results of impedance measurement, and ionic conductivity was calculated by correcting an electrode area and a pellet thickness. The results thereof are shown in Table 1 below.

A total resistance (Rtotal) value is obtained from the results of impedance measurement, and an ionic conductivity value is calculated by correcting an electrode area and a pellet thickness from this total resistance value.

TABLE 1

| | Content of | Content of the | Ionic |
|---|---|---|---|
| | first solid | second solid | conductivity |
| Class. | electrolyte (vol %) | electrolyte (vol %) | (S/cm) |
| Example 1 | 95 | 5 | 4.08 × 10⁻⁵ |
| Example 2 | 90 | 10 | 2.47 × 10⁻⁵ |
| Example 3 | 80 | 20 | 3.80 × 10⁻⁶ |
| Comparative | 100 | 0 | 5.52 × 10⁻⁷ |
| Example 1 | | | |
| Comparative | 95 | 5 | 2.78 × 10⁻⁶ |
| Example 2 | | | |
| Comparative | 90 | 10 | 1.45 × 10⁻⁷ |
| Example 3 | | | |

As shown in Table 1, the solid electrolyte of Comparative Example 1 contains c-LLZTO having a garnet crystal structure (cubic phase), and the composite solid electrolytes of Comparative Examples 2 and 3 exhibit lower ionic conductivity than the composite solid electrolytes of Examples 1 to 3.

In comparison, the composite solid electrolytes of Examples 1 to 3 exhibit higher conductivity than those of Comparative Examples 1 to 3.

### Evaluation Example 4: Relative Density

Relative densities of the composite solid electrolytes of Examples 1 to 3, the solid electrolyte of Comparative Example 1, and the composite solid electrolytes prepared according to Comparative Examples 2 and 3 were investigated and shown in Table 2 below. The relative density of the pellet was obtained as the ratio of the measured density and the theoretical density. Here, the measured density was measured by a density meter utilizing the Archimedes principle or from the apparent volume and weight of the sintered pellet, and the theoretical density of the pellet was determined by a measurement method using apparent density. The theoretical densities of Ta-doped LLZTO and Li₄B₄Al₃O₁₂Cl, which are 5.3 g/cm³ and 2.3 g/cm³, respectively, were expressed as density values when the mixing ratio of the first solid electrolyte and the second solid electrolyte was considered to be 100%.

TABLE 2

| | Content of | Content of the | Relative |
|---|---|---|---|
| | first solid | second solid | density |
| Class. | electrolyte (vol %) | electrolyte (vol %) | (%) |
| Example 1 | 95 | 5 | 95.2 |
| Example 2 | 90 | 10 | 96.2 |
| Example 3 | 80 | 20 | 97.4 |
| Comparative | 100 | 0 | 58.2 |
| Example 1 | | | |
| Comparative | 95 | 5 | 66.1 |
| Example 2 | | | |
| Comparative | 90 | 10 | 72.2 |
| Example 3 | | | |

As shown in Table 2, the composite solid electrolytes of Examples 1 to 3 have a relative density of 95% or more, which is very high compared to those of Comparative Examples 1 to 3.

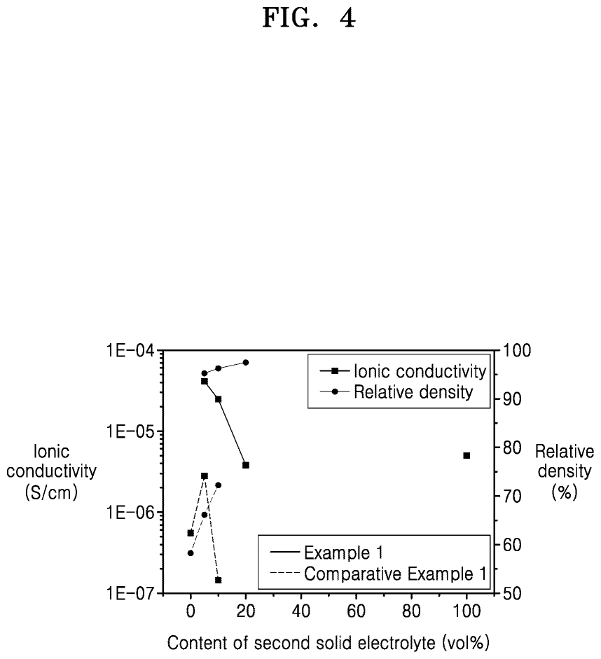

In addition, in the composite solid electrolytes of Examples 1 to 3, the solid electrolyte of Comparative Example 1, and the composite solid electrolytes prepared according to Comparative Examples 2 and 3, the ionic conductivity and relative density of the composite solid electrolyte according to the content of the second solid electrolyte are shown together in FIG. 4.

Referring to FIG. 4, it can be found that the composite solid electrolytes of Examples 1 to 3 have significantly improved relative densities and enhanced ionic conductivity compared to the solid electrolyte of Comparative Example 1 and the composite solid electrolytes of Comparative Examples 2 and 3.

As shown in FIG. 4, as the content of the second solid electrolyte increases, the ionic conductivity of the composite solid electrolyte slightly decreases, but an ionic conductivity of 2.4×10⁻⁶ S/cm or more is maintained up to a content of 10 vol % of the second solid electrolyte. Further, it can be found that as the content of the second solid electrolyte in the composite solid electrolytes of Examples 1 to 3 increases, the relative density of the composite solid electrolyte greatly increases, and as the content of the first solid electrolyte in the composite solid electrolyte increases, the ionic conductivity of the composite solid electrolyte further increases. It can be found that the relative density of the composite solid electrolytes of Examples 1 to 3 is very excellent, 95% or more, when the content of the second solid electrolyte is 5 vol % to 20 vol %. From this, it can be found that deformable characteristics of the second solid electrolyte contribute to an increase in the relative density of the composite solid electrolyte by forming a dense interface with the first solid electrolyte.

The composite solid electrolytes of Comparative Examples 2 and 3 had a content of the second solid electrolyte of 5 vol % or 10%, respectively, and a relative density of 66.1% and 72.2%, respectively.

### Evaluation Example 5: SEM Analysis

In order to evaluate the microstructure of the composite solid electrolytes of Examples 1 and 3 and the first solid electrolyte prepared according to Preparation Example 1, SEM analysis was performed on the cross-section of each composite solid electrolyte using SU-8030 of Hitachi Inc.

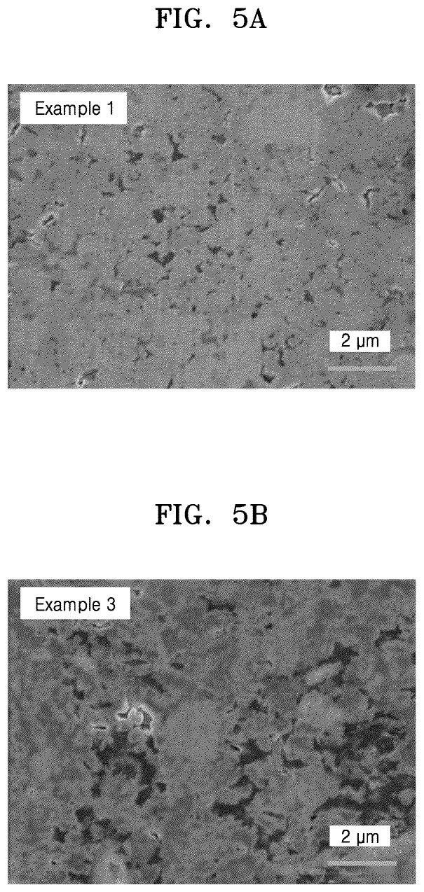

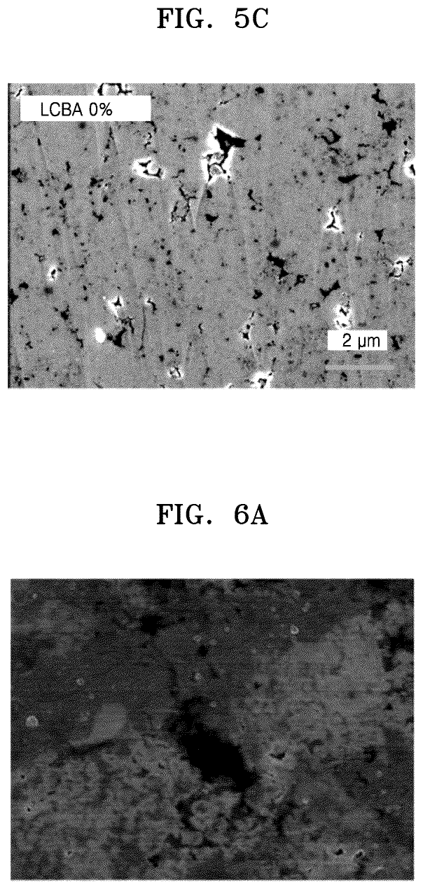

The results of SEM analysis of the cross-sections of the composite solid electrolytes of Examples 1 and 3 and the solid electrolyte prepared according to Reference Example 1 are shown in FIGS. 5A to 5C, respectively.

As shown in FIGS. 5A and 5B, it can be found that each of the composite solid electrolyte of Examples 1 and 3 has a low-temperature intense structure by having a form in which the second solid electrolyte is dispersed in a high-conductivity solid electrolyte matrix of FIG. 5C.

### Evaluation Example 6: Scanning Electron Microscope (SEM)-Energy Dispersive Spectroscopy (EDS) Analysis

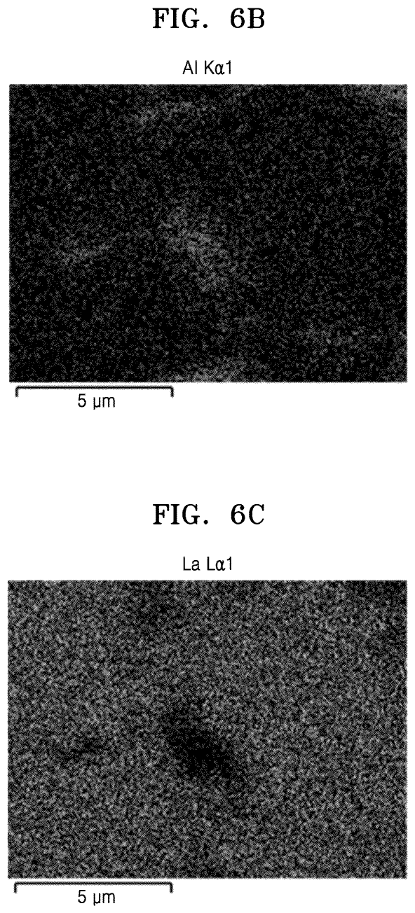

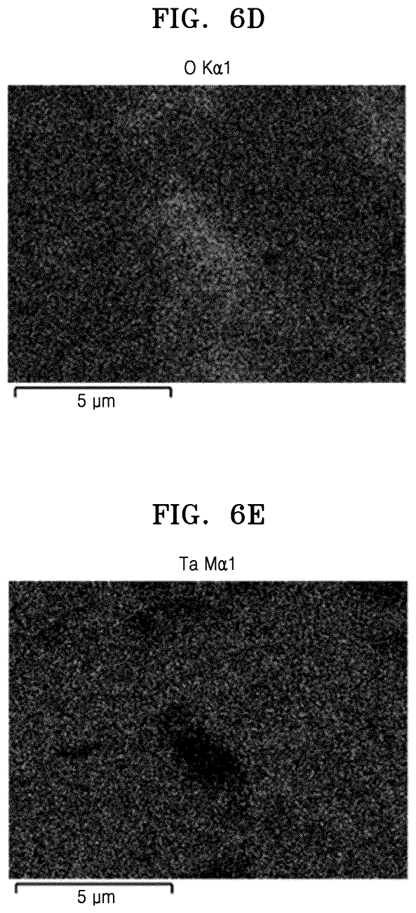

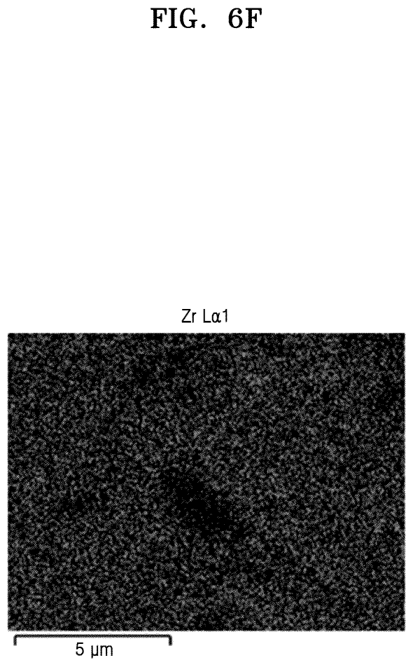

SEM-EDS analysis was performed on the cross-section of the composite solid electrolyte of Example 1. The EDS analysis results are shown in FIGS. 6A to 6F.

From the EDS analysis results, it can be confirmed that the second solid electrolyte is dispersed in the first solid electrolyte matrix, when aluminum (Al) is considered to be distributed in the composite solid electrolyte of Example 1.

Evaluation Example 7: ⁷Li-nuclear magnetic resonance (NMR) analysis

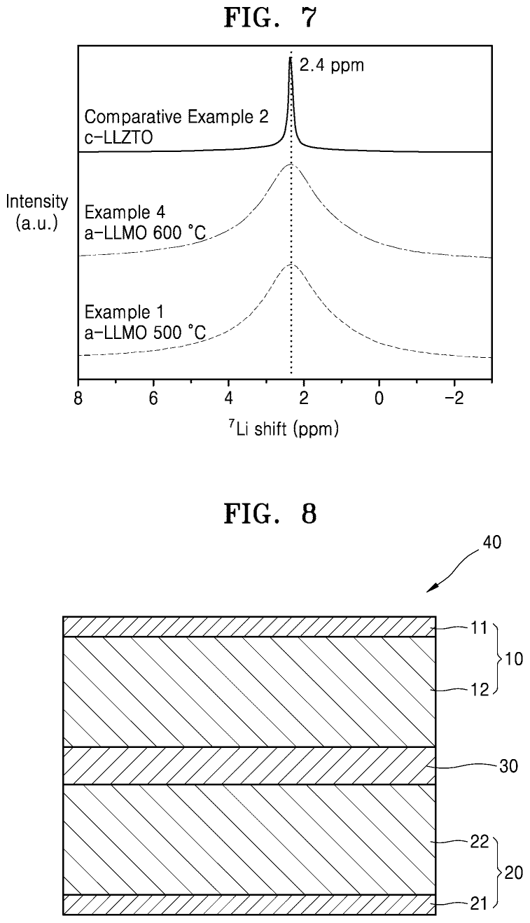

⁷Li-NMR analysis was performed on the composite solid electrolytes of Example 1, Example 4, and Comparative Example 2, and is shown in FIG. 7. ⁷Li-NMR analysis was performed under the following conditions.

Spectrometer: AVANCE HD-III (manufactured by Bruker Inc.)

Observation nucleus: 7 Li (resonance frequency 117 MHZ), Measurement method: MATPASS method, MAS condition: 25 kHz, waiting time: 0.2 second, Number of integrations: 81920

Measurement temperature: 25° C., Reference material: 1 mole per liter (mol/L) LiCI aqueous solution

As shown in FIG. 7, the composite solid electrolytes of Examples 1 and 4 show first and second peaks appearing in-2 ppm to 8 ppm, regardless of hot-press sintering temperature, and the comparative solid electrolyte of Comparative Example 2 shows a third peak appearing in 1 ppm to 3 ppm.

All of the first to third peaks show the same peak center with a chemical shift of 2.4 ppm. Here, the peak center is a location of the vertex of the peak, where the vertex represents a location that exhibits the maximum intensity.

The full width at halt maximum (FWHM) values of the first peak of the composite solid electrolyte of Example 1, the second peak of the composite solid electrolyte of Example 4, and the third peak of the composite solid electrolyte of Comparative Example 2 were evaluated and are shown in Table 3 below.

TABLE 3

| | ⁷Li-NMR |
|---|---|
| Class. | FWHM(ppm) |
| Example 1 | 2.25 |
| Example 4 | 2.24 |
| Comparative | 0.17 |
| Example 2 | |

Referring to Table 3, the composite solid electrolyte of Comparative Example 2 had a FWHM of 0.17 ppm.

In comparison, the composite solid electrolytes of Examples 1 and 4 were synthesized at a low temperature of 500° C. or 600° C., and exhibited a broad peak shape with a FWHM of more than 2.0 ppm compared to that of Comparative Example 2. The composite solid electrolytes of Examples 1 and 4 may contain multiple elements, crystallize at low temperatures, and have a somewhat disordered local structure. It can be found that this structure influences an increase in the size of FWHM. In this way, a difference in local environmental of lithium can be clearly distinguished by comparing the composite solid electrolyte of Comparative Example 2 prepared at a conventional high temperature according to the formation temperature through lithium NMR analysis.

### Evaluation Example 8: Mechanical Properties

The mechanical properties of the powdered solid electrolyte precursors prepared according to Preparation Example 1 and Reference Preparation Example 1 and the crystalline solid electrolyte of Comparative Preparation Example 1 were evaluated using a universal testing machine (UTM). The results of mechanical properties are shown in Table 4 below.

TABLE 4

| | | Yield pressure |
|---|---|---|
| Class. | Composition material | (MPa) |
| Preparation | Amorphous | 467.0 |
| Example 1 | Li_{6.5}La₃Zr_{0.4}Hf_{0.4}Sn_{0.4}Sc_{0.15}Ta_{0.65}O₁₂ | |
| Comparative | Crystalline | 536.5 |
| Preparation | Li_{6.5}La₃Zr_{1.5}Ta_{0.5}O₁₂ | |
| Example 1 | | |
| Reference | Amorphous | 494.5 |
| Preparation | Li_{6.5}La₃Zr_{1.5}Ta_{0.5}O₁₂ | |
| Example 1 | | |

As shown in Table 4, it can be found that the solid electrolyte precursor of Preparation Example 1 has very soft mechanical properties with a reduced yield pressure compared to the solid electrolyte precursors of Comparative Preparation Example 1 and Reference Preparation Example 1. From this, the solid electrolyte precursor of Preparation Example 1 shows improved mechanical properties by using a multi-cation material.

In addition, it was found that the amorphous solid electrolyte precursor of Reference Preparation Example 1 was prepared through a high-energy ball mill compared to the crystalline solid electrolyte of Comparative Preparation Example 1, and its mechanical properties were softer.

According to an aspect, a composite solid electrolyte according to an embodiment having high relative density and ensuring conductivity and compactness can be prepared. When this composite solid electrolyte is used, a lithium battery capable of low-temperature sintering and having improved energy density and cycle characteristics can be manufactured.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite solid electrolyte comprising: a first solid electrolyte containing a cubic garnet phase; and a second solid electrolyte containing lithium haloboracite,
wherein the first solid electrolyte is a garnet-containing solid electrolyte comprising a compound having a cubic crystal phase and represented by Formula 1,
the composite solid electrolyte has a peak at about −2 parts per million to about 8 parts per million in a ⁷Li nuclear magnetic resonance spectrum, and the peak has a full width at half maximum of about 0.3 parts per million to about 4.0 parts per million,
the lithium haloboracite comprises chlorine, bromine, iodine, or a combination thereof, and
the first solid electrolyte has a larger volume than the second solid electrolyte: 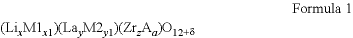
wherein, in Formula 1, M1 is a monovalent cation, a divalent cation, a trivalent cation, or a combination thereof,
M2 is a monovalent cation, a divalent cation, a trivalent cation, a tetravalent, or a combination thereof,
A comprises two or more of a monovalent cation, a divalent cation, a trivalent cation, a tetravalent cation, or a pentavalent cation,
6≤x≤8, 0≤x1≤2, 0<y≤4, 0≤y1≤4, 0<z≤3, and 0<a≤3, and
δ is a value determined to satisfy a charge neutrality condition and satisfies −1≤0≤1.

2. The composite solid electrolyte of claim 1, wherein A comprises three or more of a monovalent cation, a divalent cation, a trivalent cation, a tetravalent cation, or a pentavalent cation.

3. The composite solid electrolyte of claim 1, wherein A is sodium, potassium, calcium, magnesium, gallium, aluminum, indium, scandium, niobium, tantalum, antimony, tin, hafnium, tungsten, tellurium, or a combination thereof.

4. The composite solid electrolyte of claim 1, wherein the peak has a full width at half maximum of about 2.0 parts per million to about 3.0 parts per million.

5. The composite solid electrolyte of claim 1,
the first solid electrolyte comprises a compound represented by Formula 2, a compound represented by Formula 2-1, or a combination thereof: 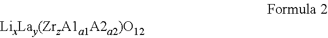
wherein, in Formula 2, A1 is at least one of a monovalent cation, a divalent cation, or a trivalent cation,
A2 is at least one of a tetravalent cation or a pentavalent cation, and
6≤x≤8, 0<y≤4, 0<z≤3, 0<a1≤1, 0<a2≤2, and 0<a1+a2≤3, 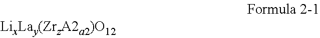
wherein in Formula 2-1, A2 comprises two or more of a tetravalent cation or a pentavalent cation, and
6≤x≤8, 0<y≤4, 0<z≤3, and 0<a2≤3.

6. The composite solid electrolyte of claim 5, A1 is at least one of sodium, potassium, calcium, magnesium, gallium, aluminum, indium, scandium, or a combination thereof, and
A2 comprises two or more of tin, hafnium, niobium, tantalum, or antimony.

7. The composite solid electrolyte of claim 1, wherein the compound of Formula 1 comprises a compound of Formula 4, a compound of Formula 5, or a combination thereof: 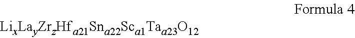
wherein, in Formula 4, 6≤x≤8, 2≤y≤4, 1≤z≤3, 0<a1≤1, 0<a21≤0.75, 0<a22≤0.75, 0<a23≤1.5, a21+a22+a23=a2, and 0<a2≤2, 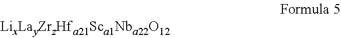
wherein, in Formula 5, 6≤x≤8, 0<y≤4, 0<z≤3, 0<a1≤1, 0<a21≤1.5, 0<a22≤1.5, a21+a22=a2, and 0<a2≤3.

8. The composite solid electrolyte of claim 1, further comprising a pyrochlore phase.

9. The composite solid electrolyte of claim 1, wherein a crystallization temperature of the first solid electrolyte is lower than a crystallization temperature of the second solid electrolyte.

10. The composite solid electrolyte of claim 1, wherein the composite solid electrolyte has an ionic conductivity of about 1×10⁻⁶ Siemens per centimeter to about 1×10⁻³ Siemens per centimeter at 25° C. and 1 atmosphere.

11. The composite solid electrolyte of claim 1, wherein the composite solid electrolyte has a relative density of about 95% to about 99.9%.

12. The composite solid electrolyte of claim 1, wherein the second solid electrolyte is a compound represented by Formula 6: 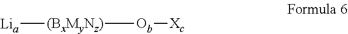
wherein, in Formula 6, a is a number of 4 to 7, b is a number of 12 to 13,
c is a number of greater than 0 and equal to or less than 1, and 0<x≤7, 0≤y≤3, O≤z≤1, and 6≤x+y+z≤7,
M and N are each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W, and
X is Cl, Br, I, or a combination thereof.

13. A lithium battery comprising: a cathode; an anode; and an electrolyte layer between the cathode and the anode,
wherein at least one of the cathode, the anode, and the electrolyte layer comprises
a composite solid electrolyte including a first solid electrolyte and a second solid electrolyte, wherein the first solid electrolyte contains a cubic garnet phase, and the second solid electrolyte contains a lithium haloboracite,
wherein the first solid electrolyte comprises a compound having a cubic crystal phase and represented by Formula 1,
the composite solid electrolyte has a peak at about −2 parts per million to about 8 parts per million in a ⁷Li nuclear magnetic resonance spectrum, and the peak has a full width at half maximum of about 0.3 parts per million to about 4.0 parts per million,
the lithium haloboracite comprises chlorine, bromine, iodine, or a combination thereof, and
the first solid electrolyte has a larger volume than the second solid electrolyte: 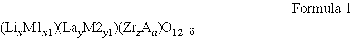
wherein, in Formula 1, M1 is a monovalent cation, a divalent cation, a trivalent cation, or a combination thereof,
M2 is a monovalent cation, a divalent cation, a trivalent cation, a tetravalent, or a combination thereof,
A comprises two or more of a monovalent cation, a divalent cation, a trivalent cation, a tetravalent cation, or a pentavalent cation,
6≤x≤8, 0≤x1≤2, 0<y≤4, 0≤y1≤4, 0<z≤3, and 0<a≤3, and
δ is a value determined to satisfy a charge neutrality condition and satisfies −1≤δ≤1.

14. The lithium battery of claim 13, wherein the second solid electrolyte is a compound represented by Formula 6: 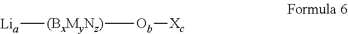
wherein, in Formula 6, a is a number of 4 to 7, b is a number of 12 to 13,
c is a number of greater than 0 and equal to or less than 1, and 0<x≤7, 0≤y≤3, 0≤z≤1, and 6≤x+y+z≤7,
M and N are each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W, and
X is Cl, Br, I, or a combination thereof.

15. The lithium battery of claim 13, wherein the compound of Formula 1 comprises a compound of Formula 4, a compound of Formula 5, or a combination thereof: 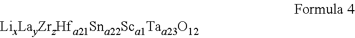
wherein, in Formula 4, 6≤x≤8, 2≤y≤4, 1≤z≤3, 0<a1≤1, 0<a21≤0.75, 0<a22≤0.75, 0<a23≤1.5, a21+a22+a23=a2, and 0<a2≤2, 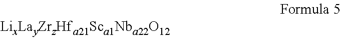
wherein, in Formula 5, 6≤x≤8, 0<y≤4, 0<z≤3, 0<a1≤1, 0<a21≤1.5, 0<a22≤1.5, a21+a22=a2, and 0<a2≤3.

16. A method of preparing a composite solid electrolyte, the method comprising:
mixing a first solid electrolyte precursor having an amorphous phase and a second solid electrolyte precursor having a glass phase, to prepare a composition for forming the composite solid electrolyte; and
heat-treating the composition for forming the composite solid electrolyte,
wherein the method of preparing the composite solid electrolyte is for preparing the composite solid electrolyte comprising: a first solid electrolyte containing a cubic garnet phase; and a second solid electrolyte containing a lithium haloboracite,
the first solid electrolyte is a garnet-containing solid electrolyte comprising a compound having a cubic crystal phase and represented by Formula 1,
the composite solid electrolyte has a peak at about −2 parts per million to about 8 parts per million in a ⁷Li nuclear magnetic resonance spectrum, and the peak has a full width at half maximum of about 0.3 parts per million to about 4.0 parts per million,
the lithium haloboracite comprises chlorine, bromine, iodine, or a combination thereof, and
the first solid electrolyte has a larger volume than the second solid electrolyte: 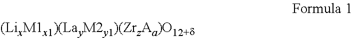
wherein, in Formula 1, M1 is a monovalent cation, a divalent cation, a trivalent cation, or a combination thereof,
M2 is a monovalent cation, a divalent cation, a trivalent cation, a tetravalent cation, or a combination thereof,
A comprises two or more of a monovalent cation, a divalent cation, a trivalent cation, a tetravalent cation, or a pentavalent cation,
6≤x≤8, 0≤x1≤2, 0<y≤4, 0≤y1≤4, 0<z≤3, and 0<a≤3, and
δ is a value determined to satisfy a charge neutrality condition, and satisfies-1≤δ≤1.

17. The method of claim 16, wherein the second solid electrolyte is a compound represented by Formula 6: 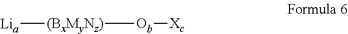
wherein, in Formula 6, a is a number of 4 to 7, b is a number of 12 to 13,
c is a number of greater than 0 and equal to or less than 1, 0<x≤7, 0≤y≤3, 0≤z≤1, and 6≤x+y+z$7, M and N are each independently at least one of Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, or W, and X is CI, Br, I, or a combination thereof.

18. The method of claim 16, wherein the composition for forming the composite solid electrolyte is heat-treated at 600° C. or lower.

19. The method of claim 16,
wherein the first solid electrolyte has a crystallization temperature of about 300° C. to about 450° C., and
the second solid electrolyte has a crystallization temperature of about 450° C. to about 550° C.

20. The method of claim 16, wherein the composite solid electrolyte is a heat treatment product of the composition for forming the composite solid electrolyte, the composition containing the first solid electrolyte precursor and the second solid electrolyte precursor, and a heat treatment temperature of the composition for forming the composite solid electrolyte is 600° C. or lower,
a crystallization temperature of the first solid electrolyte, the heat treatment temperature of the composition for forming the composite solid electrolyte, and a crystallization temperature of the second solid electrolyte satisfy Expression 1:
$$the crystallization temperature of \\ the first solid electrolyte < \\ the crystallization temperature of \\ the second solid electrolyte < \\ the heat treatment temperature of the composition \\ for forming a composite solid electrolyte . \qquad Expression 1$$
